(19) United States
(12) Patent Application Publication
(10) Pub. No.: US 2025/0338830 A1
(43) Pub. Date: Nov. 6, 2025

(54) AI-BASED LIVESTOCK MANAGEMENT SYSTEM AND LIVESTOCK MANAGEMENT METHOD THEREOF

(71) Applicant: IT TECH CO., Anyang-si (KR)

(72) Inventor: Dong Ro KIM, Yesan-gun (KR)

(73) Assignee: IT TECH CO., Anyang-si (KR)

(21) Appl. No.: 19/272,554

(22) Filed: Jul. 17, 2025

Related U.S. Application Data
(63) Continuation-in-part of application No. 17/486,877, filed on Sep. 27, 2021.
Application No. 17/486,877 is a continuation of application No. PCT/KR2020/015180, filed on Nov. 3, 2020.

(30) Foreign Application Priority Data
Apr. 27, 2020 (JP) 10-2020-0051068

(51) Int. Cl. A01K 29/00; G06V 10/141; G06V 40/10; G06V 40/20

(52) U.S. Cl. CPC A01K 29/005; G06V 10/141; G06V 40/10; G06V 40/20

(57) ABSTRACT

Disclosed is an Artificial Intelligence (AI)-based livestock management system and a livestock management method therefor. According to the inventive concept, it is possible to determine whether the animal has abnormal symptoms by learning the standard livestock stall management data and analyzing the body temperature information and behavior information of livestock from livestock image data obtained in real time from livestock such as cattle, thus giving the manager confidence.

### CROSS-REFERENCE TO RELATED APPLICATIONS

The present application is a Continuation-in-Part of U.S. patent application Ser. No. 17/486,877, filed on Sep. 27, 2021, which is a continuation of International Patent Application No. PCT/KR2020/015180, filed on Nov. 3, 2020, which is based upon and claims the benefit of priority to Korean Patent Application No. 10-2020-0051068 filed on Apr. 27, 2020. The disclosures of the above-listed applications are hereby incorporated by reference herein in their entirety.

### BACKGROUND

Embodiments of the inventive concept described herein relate to an artificial intelligence (AI)-based livestock management system capable of determining whether a livestock has an abnormal symptom by learning standard livestock stall management data and analyzing body temperature information and behavior information from livestock image data obtained in real time from the livestock such as cattle and a livestock management method thereof.

Conventionally, a person figures out the state of each livestock, and allows the livestock to receive medical treatment or isolates the livestock with abnormal symptoms. However, when the number of livestock is large, there is a problem that a large number of manpower is required to manage all the livestock.

In addition, when an infectious disease occurs in some livestock, it may result in the death of most of the livestock, thus resulting in a need for a method for quickly and accurately determining whether the livestock is abnormal.

In addition, in the reality that diseases occurring in a specific area are not limited to a specific place and spread quickly throughout the country due to the development of transportation means, early diagnosis of the disease is required. In determining the disease of the livestock, a temperature measurement method according to the fever is used as a reference for determining the presence or absence of disease.

However, since consistent temperature measurement is performed on many livestock, there is a difficulty in determining diseases according to the state of each livestock. In addition, the method of determining a disease based on temperature measurement has difficulty in detecting an individual at an early stage of disease development.

Moreover, livestock reared in groups within narrow livestock house are very vulnerable to the spread of communicable diseases. Accordingly, as consumption of livestock products increases, various methods for efficiently managing livestock have been proposed.

### SUMMARY

Embodiments of the inventive concept provide an Artificial Intelligence (AI)-based livestock management system and a livestock management method thereof.

However, problems to be solved by the inventive concept are may not be limited to the above-described problems. Although not described herein, other problems to be solved by the inventive concept can be clearly understood by those skilled in the art from the following description.

According to an embodiment, an Artificial Intelligence (AI)-based livestock management system includes a manager terminal for a livestock stall, a livestock stall control device that detects at least one of a situation of the livestock stall and an abnormal symptom of a plurality of livestock in the livestock stall through a sensor unit, and acquires livestock image data obtained by photographing the plurality of livestock in the livestock stall through at least one of an imaging camera and a thermal imaging camera, in real time, a management server that receives the livestock image data from the livestock stall control device in real time, separates the plurality of livestock included in the livestock image data into individual objects, extracts object information from the livestock image data, the object information including object body temperature information and object behavior information for the individual objects, generates determination result data obtained by determining at least one abnormal symptom of at least one livestock in the livestock stall by analyzing standard livestock stall management data and the object information based on deep learning technique, transmits the generated determination result data to the manager terminal in real time, and controls the livestock stall control device to change a livestock farming environment of the livestock stall based on the determined at least one abnormal symptom, wherein the standard livestock stall management data includes object basic temperature information generated by repeatedly learning highest body temperature information and lowest body temperature information of a normal object which do not have an abnormal symptom and a surrounding object of the normal object, livestock stall basic temperature information generated by repeatedly learning highest temperature information and lowest temperature information of a normal livestock stall and a surrounding livestock stall of the normal livestock stall, and object basic behavior information generated by analyzing normal behavior of the normal object, the standard livestock stall management data being updated based on the determination result data, wherein the abnormal symptom of the livestock includes a birthing symptom and a mounting symptom, wherein the management server may determine whether the livestock has the abnormal symptom, and classify the abnormal symptom into any one of the birthing symptom and the mounting symptom by using deep learning technique based on the standard livestock stall management data, compare and analyze the object body temperature information and the object basic temperature information included in the standard livestock stall management data, and compare and analyze the object behavior information and the object basic behavior information included in the standard livestock stall management data, predict birthing situation information including an expected birthing time, a required birthing time, and a number of young objects to be born by monitoring behavior information of a mother object determined as having the birthing symptom, generate information on the predicted birthing situation and transmits the information to the manager terminal, when predicting the birthing situation, monitor object body temperature information and object behavior information of the young object in consideration of environment information after birthing of the mother object, the environment information including weather information, season information and time information for surroundings of at least one of the mother object and the livestock stall, when the young object has an abnormal symptom as a result of the monitoring, transmit a first message notifying that the young object has the abnormal symptom to the manager terminal, when it is determined that the mother object delivers the young object in a preset season, a preset weather and a preset time zone based on the environment information, continuously monitor a body temperature of the young object for a preset time of period, when the body temperature of the young object is a hypothermia that is less than or equal to a preset temperature as a result of the monitoring, transmit a second message notifying that the young object is a hypothermia to the manager terminal, when the body temperature of the young object is less than or equal to a preset temperature, indicating that the young object is a hypothermia, as a result of the monitoring, generate a signal for brightening a lighting of the livestock stall to a preset brightness while raising an internal temperature of the livestock stall to a preset temperature, and transmit the signal to the livestock stall control device, predict mounting situation including a number of objects before estrus, an expected time in estrus, a number of expected objects in estrus, and an expected period in non-pregnant condition by monitoring behavior information of an object in estrus determined as having the mounting symptom, generate information on the predicted mounting situation and transmits the information to the manager terminal, generate a signal capable of enabling the object in estrus and a target object expected to be mounted by the object in estrus to be located in a same space by using the information on the mounting situation and transmit the signal to the livestock stall control device when the object in estrus is determined as having the mounting symptom in case of predicting the mounting symptom.

The abnormal symptom of the livestock may include a disease symptom, and the management server may determine that the abnormal symptom of the livestock is the disease symptom based on a result of comparing and analyzing the body temperature information and the object basic temperature information, and the behavior information and the object basic behavior information, and predict a disease spread path by monitoring the body temperature information of a diseased object determined as having the disease symptom. The management server may, in case of predicting the disease spread path, acquire first object temperature information by measuring a body temperature of the diseased object, acquire second object temperature information by measuring a body temperature of a surrounding object of the diseased object, and predict the disease spread path by calculating a first temperature difference between the first object temperature information and the second object temperature information based on the object basic temperature information. The management server may, in case of predicting the disease spread path, acquire first livestock stall temperature information by measuring a temperature of a disease livestock stall in which the diseased object is located, acquire second livestock stall temperature information by measuring a temperature of a surrounding livestock stall of the disease livestock stall, and predict the disease spread path by calculating a second temperature difference between the first livestock stall temperature information and the second livestock stall temperature information based on the livestock stall basic temperature information.

According to an embodiment, a livestock management method for an Artificial Intelligence (AI)-based livestock management system including a manager terminal for a livestock stall, a livestock stall control device, and a management server includes detecting, through a sensor unit of the livestock stall control device, at least one of a situation of the livestock stall and an abnormal symptom of a plurality of livestock in the livestock stall, acquiring, through at least one of an imaging camera and a thermal imaging camera of the livestock stall control device, livestock image data obtained by photographing the plurality of livestock in the livestock stall, in real time, receiving, through the management server, the livestock image data from the livestock stall control device in real time, separating, through the management server, the plurality of livestock included in the livestock image data into individual objects, extracting, through the management server, object information from the livestock image data, the object information including object body temperature information and object behavior information for the individual objects, generating, through the management server, determination result data obtained by determining at least one abnormal symptom of at least one livestock in the livestock stall by analyzing standard livestock stall management data and the object information based on deep learning technique, transmitting, through the management server, the generated determination result data to the manager terminal in real time, and controlling, through the management server, the livestock stall control device to change a livestock farming environment of the livestock stall based on the determined at least one abnormal symptom, wherein the standard livestock stall management data includes object basic temperature information generated by repeatedly learning highest body temperature information and lowest body temperature information of a normal object which do not have an abnormal symptom and a surrounding object of the normal object, livestock stall basic temperature information generated by repeatedly learning highest temperature information and lowest temperature information of a normal livestock stall and a surrounding livestock stall of the normal livestock stall, and object basic behavior information generated by analyzing normal behavior of the normal object, the standard livestock stall management data being updated based on the determination result data, wherein the abnormal symptom of the livestock includes a birthing symptom and a mounting symptom, wherein the management server is configured to determine whether the livestock has the abnormal symptom, and classify the abnormal symptom into any one of the birthing symptom and the mounting symptom by using deep learning technique based on the standard livestock stall management data, compare and analyze the object body temperature information and the object basic temperature information included in the standard livestock stall management data, and compare and analyze the object behavior information and the object basic behavior information included in the standard livestock stall management data, predict birthing situation information including an expected birthing time, a required birthing time, and a number of young objects to be born by monitoring behavior information of a mother object determined as having the birthing symptom, generate information on the predicted birthing situation and transmits the information to the manager terminal, when predicting the birthing situation, to monitor object body temperature information and object behavior information of the young object in consideration of environment information after birthing of the mother object, the environment information including weather information, season information and time information for surroundings of at least one of the mother object and the livestock stall, when the young object has an abnormal symptom as a result of the monitoring, to transmit a first message notifying that the young object has the abnormal symptom to the manager terminal, when it is determined that the mother object delivers the young object in a preset season, a preset weather and a preset time zone based on the environment information, to continuously monitor a body temperature of the young object for a preset time of period, when the body temperature of the young object is a hypothermia that is less than or equal to a preset temperature as a result of the monitoring, to transmit a second message notifying that the young object is a hypothermia to the manager terminal, when the body temperature of the young object is less than or equal to a preset temperature, indicating that the young object is a hypothermia, as a result of the monitoring, to generate a signal for brightening a lighting of the livestock stall to a preset brightness while raising an internal temperature of the livestock stall to a preset temperature, and transmit the signal to the livestock stall control device, predict mounting situation including a number of objects before estrus, an expected time in estrus, a number of expected objects in estrus, and an expected period in non-pregnant condition by monitoring behavior information of an object in estrus determined as having the mounting symptom, generate information on the predicted mounting situation and transmits the information to the manager terminal, generate a signal capable of enabling the object in estrus and a target object expected to be mounted by the object in estrus to be located in a same space by using the information on the mounting situation and transmit the signal to the livestock stall control device when the object in estrus is determined as having the mounting symptom in case of predicting the mounting symptom.

Other details according to an embodiment of the inventive concept are included in the detailed description and drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a conceptual diagram for describing a smart livestock management system according to an embodiment of the inventive concept;

FIG. 2 is a detailed block diagram for describing the smart livestock management system shown in FIG. 1;

FIG. 3 is a diagram for describing a smart livestock management method according to an embodiment of the inventive concept;

FIGS. 4A and 4B are diagrams for describing a method of generating livestock image data shown in FIG. 3;

FIGS. 5A and 5B are diagrams for describing a method of separating objects and extracting object information shown in FIG. 3;

FIG. 6 is a detailed view for describing a step of generating determination result data shown in FIG. 3;

FIGS. 7A and 7B are diagrams for describing an embodiment for determining an abnormality of livestock shown in FIG. 6 as a disease symptom;

FIG. 8 is a detailed view for describing a step of predicting a disease spread path shown in FIG. 6;

FIG. 9 is a view for describing an embodiment of determining an abnormality of livestock shown in FIG. 6 as a birthing symptom;

FIG. 10 is a view for describing an embodiment of determining an abnormality of livestock shown in FIG. 6 as a mounting symptom;

FIG. 11 is a view for describing a smart livestock management method according to another embodiment of the inventive concept; and

FIG. 12 is a diagram for describing a case in which a young object shown in FIG. 11 is generated.

FIG. 13 is a diagram showing an overall configuration of a vision recognition-based cattle object flipping detection device according to an embodiment of the present disclosure.

FIG. 14 is a detailed processing flowchart of a control module according to an embodiment of the present disclosure.

FIG. 15 is a diagram showing an example of feature point extraction and movement trajectory calculation according to an embodiment of the present disclosure.

FIG. 16 is a diagram showing a flipping condition determination logic according to an embodiment of the present disclosure.

FIG. 17 is a diagram showing keypoint estimation and inclination analysis according to an embodiment of the present disclosure.

FIG. 18 is a diagram showing an example of utilizing an image artificial intelligence model according to an embodiment of the present disclosure.

FIG. 19 is a diagram showing an example of a monitoring screen and state information display according to an embodiment of the present disclosure.

FIG. 20 is a diagram showing an operation and position identification of a lamp module according to an embodiment of the present disclosure.

FIG. 21 is a diagram showing an example of an operation of a frequency analysis module according to an embodiment of the present disclosure.

### DETAILED DESCRIPTION

Advantages and features of the inventive concept and methods for achieving them will be apparent with reference to embodiments described below in detail in conjunction with the accompanying drawings. However, the inventive concept is not limited to the embodiments disclosed below, but can be implemented in various forms, and these embodiments are to make the disclosure of the inventive concept complete, and are provided so that this disclosure will be thorough and complete and will fully convey the scope of the invention to those of ordinary skill in the art, which is to be defined only by the scope of the claims.

The terminology used herein is for the purpose of describing particular embodiments only and is not intended to be limiting of the inventive concept. The singular expressions include plural expressions unless the context clearly dictates otherwise. In this specification, the terms “comprises” and/or “comprising” are intended to specify the presence of stated elements, but do not preclude the presence or addition of elements. Like reference numerals refer to like elements throughout the specification, and “and/or” includes each and all combinations of one or more of the mentioned elements. Although “first”, “second”, and the like are used to describe various components, these components are of course not limited by these terms. These terms are only used to distinguish one component from another. Thus, a first element discussed below could be termed a second element without departing from the teachings of the inventive concept

Unless otherwise defined, all terms (including technical and scientific terms) used herein have the same meaning as commonly understood by one of ordinary skill in the art to which this invention belongs. It will be further understood that terms such as those defined in commonly used dictionaries, will not be interpreted in an idealized or overly formal sense unless expressly so defined herein.

Hereinafter, embodiments of the present disclosure will be described with reference to the accompanying drawings.

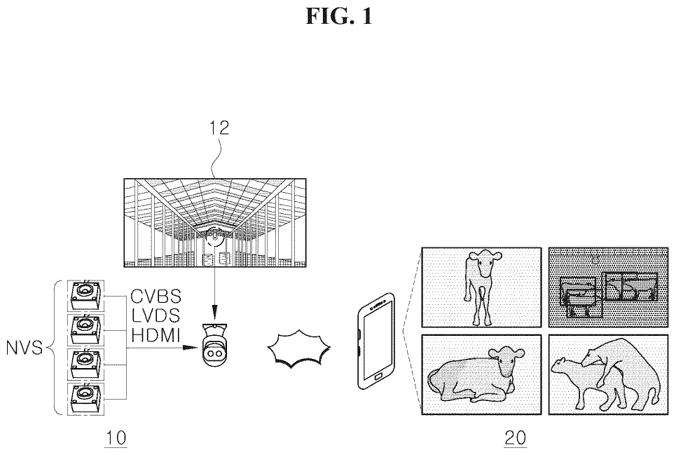

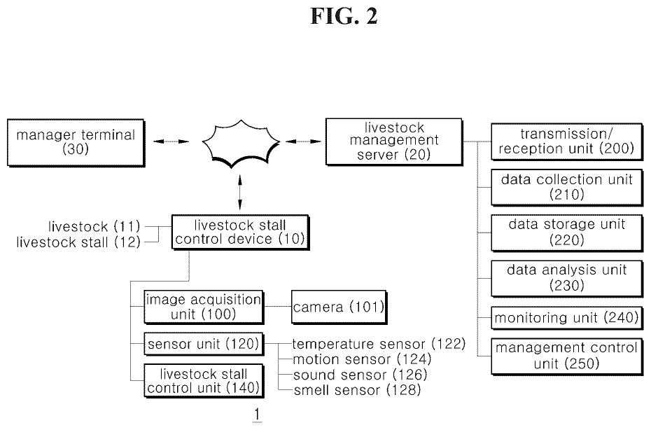

FIG. 1 is a conceptual diagram for describing a smart livestock management system according to an embodiment of the inventive concept, and FIG. 2 is a detailed block diagram for describing the smart livestock management system shown in FIG. 1.

Referring to FIGS. 1 and 2, a smart livestock management system 1 according to an embodiment of the inventive concept may include a livestock stall control device 10, a livestock management server 20, and a manager terminal 30. According to an embodiment, the manager terminal 30 may be omitted.

Here, the livestock stall control device 10 and the manager terminal 30 may be synchronized with the livestock management server 20 in real time using a wireless communication network to transmit and receive data. The wireless communication network may support various long-distance communication schemes, various communication schemes, for example, wireless LAN (WLAN), DLNA (Digital Living Network Alliance), WiBro (Wireless Broadband, Wibro), Wimax (World Interoperability for Microwave Access), GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), IEEE 802.16, Long Term Evolution (LTE), Long Term Evolution-Advanced (LTEA), WMBS (Wireless Mobile Broadband Service), BLE (Bluetooth Low Energy), Zigbee, RF (Radio Frequency), LoRa (Long Range), and the like may be applied, but are not limited thereto, and various well-known wireless or mobile communications schemes may be also applied.

In addition, the livestock stall control device 10 and the manager terminal 30 may operate using an application program or application in the present disclosure, and such an application program may be downloaded from an external server or the livestock management server 20 through wireless communication.

The livestock stall control device 10 and the manager terminal 30 may include various portable electronic communication devices that support communication with the livestock management server 20. For example, the livestock stall control device 10 and the manager terminal 30 may be separate smart devices, and may include various terminals, such as a smart phone, a personal digital assistant (PDA), a tablet, a wearable device, (including, for example, a smart watch, a smart glass, an HMD (Head Mounted Display), or the like) and various types of IoT (Internet of Things) terminals but are not limited thereto.

The livestock stall control device 10 may be a device for controlling conditions of a livestock stall 12 in which livestock 11 such as cattle and pigs as well as poultry such as chickens and ducks are reared. Here, the livestock 11 and the livestock stall 12 may be provided in plurality. In this case, an identification tag 110 may be attached to each livestock 11. Accordingly, the livestock 11 may be recognized as an individual object by recognizing each identification tag 110 in livestock image data.

The livestock stall control device 10 may include an image acquisition unit 100, a sensor unit 120, and a livestock stall control unit 140.

The image acquisition unit 100 may obtain image information by photographing the livestock 11 and surrounding environments of the livestock stall 12 by using a plurality of cameras 101 disposed inside and outside the livestock stall 12. Here, the camera 101 may include a photographing device such as a Digital Video Recorder (DVR), a Network Video Recorder (NVR), a Network Video Server (NVS), an Infrared Camera, a Thermo-graphic Camera, or a camera equipped with a Wide Angle Lens or Fish Eye Lens that is effective against water and dust, but is not limited thereto.

In this embodiment, the image acquisition unit 100 may acquire image information containing a general image photographed using a general camera and a thermal image photographed using a thermal imaging camera.

For example, the image acquisition unit 100 may be located inside the livestock stall 12 to photograph the movement of the livestock 11, and may be located outside the livestock stall 12 to photograph an external environment, that is, external intrusion or fire occurrence to acquire image information.

In particular, the image acquisition unit 100 may acquire image information by photographing the inside and outside of the livestock stall 12 using a thermal imaging camera to figure out a disease of the livestock 11 more quickly.

The sensor unit 120 may acquire sensor information by recognizing abnormal symptoms of the livestock 11 located in the livestock stall 12. Here, the sensor unit 120 may include a temperature sensor 122, a motion sensor 124, a sound sensor 126, a smell sensor 128 and the like, but is not limited thereto.

For example, the sensor unit 120 may detect a temperature inside and outside the livestock stall 12 using the temperature sensor 122. For example, a body temperature of the livestock 11 located inside the livestock stall 12, an interior temperature of the livestock stall 12, and an exterior temperature of the livestock stall 12 may be detected.

In addition, the sensor unit 120 may detect a movement inside and outside the livestock stall 12 using the motion sensor 124. For example, the movement of the livestock 11 located inside the livestock stall 12 or the movement of a manager or a visitor outside the livestock stall 12 may be detected.

In addition, the sensor unit 120 may detect sound inside and outside the livestock stall 12 using the sound sensor 126. For example, it is possible to detect cries of the livestock 11 located inside the livestock stall 12 and noise inside and outside the livestock stall 12.

In addition, the sensor unit 120 may detect smell inside and outside the livestock stall 12 using the smell sensor 128. For example, it is possible to detect smell inside and outside the livestock stall 12, such as the smell of excrement of the livestock 11 located inside the livestock stall 12 and the smell generated when fire occurs in the livestock stall 12.

Accordingly, by using sensor information acquired through the sensor unit 120, it is possible to more accurately determine whether an abnormality of the livestock 11 is a disease symptom, a birthing symptom, and a mounting symptom.

The livestock stall control unit 140 may generate livestock image data from image information obtained from the image acquisition unit 100.

For example, the livestock stall control unit 140 may generate livestock image data by converting image information acquired by receiving image information, obtained through the image acquisition unit 100, through a USB terminal, a CVBS (Composite Video Banking Sync) terminal, a component terminal, an S-video terminal (analog), a DVI (Digital Visual Interface) terminal, an HDMI (High Definition Multimedia Interface) terminal, an RGB terminal, a D-SUB terminal, or the like.

For example, the livestock stall control unit 140 may generate the livestock image data by matching a general image photographed using a general camera with a thermal image photographed using a thermal imaging camera.

According to an embodiment, the livestock stall control unit 140 may generate the livestock image data by converting the image information acquired from the image acquisition unit 100 and the sensor information acquired from the sensor unit 120.

For example, the livestock stall control unit 140 may convert big data including the image information obtained from the image acquisition unit 100 and the sensor information obtained from the sensor unit 120 to be transmitted/received smoothly to generate livestock image data.

According to an embodiment, the livestock stall control unit 140 may generate livestock image data in consideration of current situation information including real-time weather information, season information, and time information of the livestock 11 and the livestock stall 12 in which the livestock 11 is located.

According to an embodiment, the livestock stall control unit 140 may generate livestock image data in consideration of current situation information including real-time weather information, season information, and time information of the livestock 11 and the livestock stall 12 in which the livestock 11 is located, image information, and sensor information.

The livestock stall control unit 140 may transmit the livestock image data to the livestock management server 20 and/or the manager terminal 30 in real time.

According to an embodiment, the livestock stall control unit 140 may transmit the image information to the livestock management server 20 and/or the manager terminal 30.

According to an embodiment, the livestock stall control unit 140 may transmit the image information and the sensor information to the livestock management server 20 and/or the manager terminal 30.

According to an embodiment, the livestock stall control unit 140 may receive a feedback signal generated in response to determination result data, and control the livestock stall control device 10 in real time for a photographing direction of the camera unit 101, a sound level or turning-on/off of a warning sound, and an luminous intensity or turning-on/off of a lighting, turning-on/off of a door of the livestock stall 12, turning-on/off of fire facility, or the like.

The livestock management server 20 may include a data transmission/reception unit 200, a data collection unit 210, a data storage unit 220, a data analysis unit 230, a monitoring unit 240, and a management control unit 250.

The data transmission/reception unit 200 may receive livestock image data from the livestock stall control device 10, and transmit a feedback signal to the livestock stall control device 10.

According to an embodiment, the data transmission/reception unit 200 may transmit livestock image data and standard livestock stall management data to the manager terminal 30, and receive the determination result data and the feedback signal corresponding to the determination result data from the manager terminal 30.

The data collection unit 210 may collect data included in the livestock image data.

Specifically, the data collection unit 210 may extract highest body temperature information and lowest body temperature information of a normal livestock that do not have an abnormal symptom and a surrounding livestock of the normal livestock, from the livestock image data.

In addition, the data collection unit 210 may recognize the identification tag 110 attached to the livestock 11 from the livestock image data, and extract highest temperature information and lowest temperature information of a normal livestock stall where the normal object is located, and a surrounding livestock stall of the normal livestock stall.

In addition, the data collection unit 210 may extract object information including object body temperature information and object behavior information of a diseased object and a surrounding object of the diseased object from the livestock image data.

Also, the data collection unit 210 may extract environment information including temperature information of a disease livestock stall where a diseased object is located and a surrounding livestock stall of the disease livestock stall from the livestock image data. According to an embodiment, the environment information may include weather information, season information, and time information of a place where an object and a livestock stall in which the object is located are located.

In addition, the data collection unit 210 may extract object information including object body temperature information and object behavior information of a pregnant object from the livestock image data.

In addition, the data collection unit 210 may extract object information including object body temperature information and object behavior information of a surrounding object after birthing of the pregnant object from the livestock image data. In addition, the data collection unit 210 may extract environment information including temperature information of a surrounding livestock stall after the birthing of the pregnant object from the livestock image data.

In addition, the data collection unit 210 may extract object information including object body temperature information and object behavior information of a mounting object and a surrounding object of the mounting object from the livestock image data.

Further, the data collection unit 210 may extract environment information including temperature information of a mounting livestock stall where a mounting object is located and a surrounding livestock stall of the mounting livestock stall from the livestock image data.

The data storage unit 220 may store data transmitted and received between the livestock stall control device 10 and the livestock management server 20 and between the livestock management server 20 and the manager terminal 30 and data supporting various functions of the livestock management server 20. The data storage unit 220 may store a plurality of application programs (or applications) driven in the livestock management server 20, and data and commands for the operation of the livestock management server 20. At least some of these application programs may be downloaded from an external server through wireless communication.

The data analysis unit 230 may separate a plurality of livestock 11 included in the data collected through the data collection unit 210 into individual objects based on the livestock image data, and analyze object information based on the standard livestock stall management data. In this case, the data analysis unit 230 may separate the plurality of livestock 11 included in the livestock image data into the individual objects using the identification tag 110, but is not limited thereto.

The monitoring unit 240 may monitor data transmitted and received between the livestock stall control device 10 and the livestock management server 20 and between the livestock management server 20 and the manager terminal 30 through a screen.

According to an embodiment, by monitoring transmission and reception of data between the livestock stall control device 10 and the livestock management server 20 in real time, it is possible to give more confidence the manager terminal 30 in managing the livestock 11 by rapidly dealing with a communication error or an abnormal symptom when the communication error or the abnormal symptom in the livestock stall control device 10 occurs.

The management control unit 250 may generate standard livestock stall management data by repeatedly learning the data collected through the data collection unit 210. Here, the standard livestock stall management data may be updated in real time in response to the determination result data.

In this embodiment, the management control unit 250 may generate the standard livestock stall management data using a deep learning technique, but is not limited thereto, and machine learning techniques such as a random forest or a support vector machine may be used.

Here, the standard livestock stall management data may include object basic temperature generated by repeatedly learning the highest body temperature information and lowest body temperature information of a normal livestock and a surrounding livestock of the normal livestock and livestock stall basic temperature information generated by repeating learning the highest temperature information and the lowest temperature information of a normal livestock stall and a surrounding livestock stall of the normal livestock stall.

The management control unit 250 may determine whether the livestock 11 has an abnormal symptom by using a result of analysis of the livestock image data based on the standard livestock stall management data and generate determination result data. That is, the management control unit 250 may match the standard livestock stall management data with the livestock image data to determine whether there is an abnormal symptom, and generate the determination result data including a result of the determination. Here, the livestock image data may be data obtained by converting image information acquired through the camera 101, but may not be limited thereto.

Alternatively, image information acquired through the camera 101 and sensor information acquired from the sensor unit 120 may be converted data.

According to an embodiment, the management control unit 250 may determine whether the livestock 11 has an abnormal symptom, and classify the symptom into a disease symptom, a birthing symptom, or a mounting symptom to generate the determination result data.

For example, the management control unit 250 may determine the abnormal symptom as a disease symptom and generate the determination result data by comparing and analyzing the object body temperature information of the object information included in the livestock image data and the object basic temperature information included in the standard livestock stall management data.

Accordingly, the management control unit 250 may predict a disease spread path by monitoring the object body temperature information of a diseased object based on the determination result data of the disease symptom.

Specifically, the management control unit 250 may measure the body temperature of the diseased object and the body temperature of the surrounding object of the diseased object, and then calculate a difference in the object body temperature between the diseased object and the surrounding object of the diseased object to predict the disease spread path.

The management control unit 250 may measure the temperature of a disease livestock stall where the diseased object is located and the temperature of a surrounding livestock stall of the disease livestock stall where the diseased object is located, and calculate a difference in temperature between the disease livestock stall and the surrounding livestock stall of the disease livestock stall to determine the disease spread path.

According to an embodiment, the management control unit 250 may predict the disease spread path in consideration of the calculated difference in object body temperature and the difference in livestock stall temperature.

According to an embodiment, the management control unit 250 may determine the abnormal symptom as a disease symptom and generate the determination result data by comparing and analyzing the object body temperature information of the object information included in the livestock image data and the object basic temperature information included in the standard livestock stall management data and comparing and analyzing the object behavior information of the object information included in the livestock image data and the object basic behavior information included in the standard livestock stall management data.

In other words, when the body temperature of the object is higher or lower than the object basic body temperature information, or the object behaves such as lying down for a long time, turning around, constantly crying, or not moving at all, unlike the object basic behavior information, the management control unit 250 may make a determination as a disease symptom such as respiratory disease, fever, or stomach disease to generate the determination result data. When the determination result data indicates a disease symptom, the management control unit 250 may predict a disease spread path by using livestock stalls centering on the diseased object, surrounding objects of the diseased object, and object information and environment information of the surrounding objects.

According to the embodiment, the management control unit 250 may determine the abnormal symptom as a disease symptom and generate the determination result data by comparing and analyzing the object behavior information of the object information included in the livestock image data and the object basic behavior information included in the standard livestock stall management data.

According to an embodiment, the management control unit 250 may update the disease spread path in real time and transmit the disease spread path to the manager terminal 30 in real time.

In addition, the management control unit 250 may determine the abnormal symptom as a birthing symptom and generate the determination result data by comparing and analyzing the object body temperature information of the object information included in the livestock image data and the object basic temperature information included in the standard livestock stall management data and comparing and analyzing the object behavior information of the object information included in the livestock image data and the object basic behavior information included in the standard livestock stall management data.

In other words, when the object's body temperature is lower than the object's basic temperature information or the object's behavioral pattern is similar to a birthing pattern, that is, when livestock constantly raises its tail, sheds its hind paws at shorter intervals, or repeatedly engages in restless sitting and getting up, the management control unit 250 may make a determination as a birthing symptom to generate the determination result data. When the determination result data indicates a birthing symptom, the management control unit 250 may predict birthing situation information including an expected birthing time, a required birthing time, the gender of a calf, the number of objects born, and the like.

According to an embodiment, the management control unit 250 may update the birthing situation information in real time and transmit the birthing situation information to the manager terminal 30 in real time.

According to the embodiment, the management control unit 250 may determine the abnormal symptom as a birthing symptom and generate the determination result data by performing comparison and analysis based on object basic temperature information included in the standard livestock stall management data.

According to the embodiment, the management control unit 250 may determine the abnormal symptom as a birthing symptom and generate the determination result data by comparing and analyzing the object behavior information of the object information included in the livestock image data and the object basic behavior information included in the standard livestock stall management data.

According to an embodiment, the management control unit 250 may monitor object information for a young object (e.g., calf) in consideration of environment information after birthing of a pregnant object, and when an abnormal symptom occurs, transmit a notification message to the manager terminal 30.

For example, when the pregnant object delivers a young object in the late autumn night on a rainy day, the management control unit 250 may continuously monitor the young object and when a low body temperature is detected, promptly transmit a notification message to the manager terminal 30.

In addition, the management control unit 250 may determine the abnormal symptom as a mounting symptom and generate the determination result data by comparing and analyzing the object body temperature information of the object information included in the livestock image data and the object basic temperature information included in the standard livestock stall management data and comparing and analyzing the object behavior information of the object information included in the livestock image data and the object basic behavior information included in the standard livestock stall management data.

In other words, when the object's body temperature is higher than the object basic temperature information, or the behavioral pattern of the object is similar to a mounting pattern, that is, when an object licks another object, permits mounting of another object/mounts another object, cries continuously, puts its head on another object's buttocks, or performs a movement 3-4 times more than normal movement, the management control unit 250 may make a determination as a mounting symptom to generate determination result data. When the determination result data indicates the mounting symptom, the management control unit 250 may predict mounting situation information including the number of objects before estrus, an expected time in estrus, the number of expected objects in estrus, and an expected period in non-pregnant condition.

In the present embodiment, the management control unit 250 may determine the abnormal symptom as a mounting symptom by comparing and analyzing the behavior pattern of the object using a deep learning technique based on the standard livestock stall management data.

According to an embodiment, the management control unit 250 may update the mounting situation information in real time and transmit the mounting situation information to the manager terminal 30 in real time.

According to the embodiment, the management control unit 250 may determine the abnormal symptom as the mounting symptom and generate the determination result data by performing comparison and analysis based on object basic temperature information included in the standard livestock stall management data.

According to the embodiment, the management control unit 250 may determine the abnormal symptom as the mounting symptom and generate the determination result data by comparing and analyzing the object behavior information of the object information included in the livestock image data and the object basic behavior information included in the standard livestock stall management data.

According to an embodiment, the management control unit 250 may receive current situation information including real-time weather information, season information, and time information of the livestock 11 and the livestock stall 12 in which the livestock 11 is located, in real time through an external organization and match and analyze the standard livestock stall management data and the livestock image data to generate the determination result data.

According to an embodiment, the management control unit 250 may generate a feedback signal corresponding to the determination result data and transmit the feedback signal to the livestock stall control device 10 to control the livestock stall control device 10.

For example, in the case of making a determination as a disease symptom according to the determination result data, the management control unit 250 may generate a feedback signal capable of separating a diseased object and a normal object by using a predicted disease spread path of the diseased object.

In addition, in the case of making a determination as a birthing symptom according to the determination result data, the management control unit 250 may generate a feedback signal capable of separating and moving a mother object and a young object to a separate stall 11 by using the predicted birthing situation information.

In addition, in the case of making a determination as a mounting symptom according to the determination result data, the management control unit 250 may generate a feedback signal capable of enabling an object in estrus and a target object expected to be mounted by the object in estrus to be located in the same space (e.g., in the same fence, in the same room, or the like) within the stall.

The management control unit 250 may generate a feedback signal capable of ensuring the safety of a young object in consideration of the environment information when an abnormal symptom occurs in the young object according to the birthing of the pregnant object according to the determination result data. For example, the temperature inside the livestock stall 12 may be raised or the lighting of the livestock stall 12 may be brightened.

On the other hand, the management control unit 250 may transmit a warning message to the manager terminal 30 when an outsider visits the livestock stall 12 or a dangerous situation such as a fire occurs in the livestock 11 and the livestock stall 12.

According to an embodiment, the management control unit 250 may control the livestock stall control device 10 for a photographing direction of the camera unit 101, a sound level or turning-on/off of a warning sound, and an luminous intensity or turning-on/off of a lighting, turning-on/off of a door of the livestock stall 12, turning-on/off of fire facility, or the like, when an outsider visits the livestock stall 12 or a dangerous situation such as a fire occurs in the livestock 11 and the livestock stall 12.

In some embodiments, the management control unit 250 may generate livestock image data by using the image information and/or sensing information received from the livestock stall control device 10.

The manager terminal 30 may be a portable terminal possessed by the manager, which recognizes a situation of the livestock stall control device 10 in real time using an application program (or application) and control operation of the livestock stall control device 10 in response to the condition, and may download the application program from an external server or the livestock management server 20 through wireless communication. Here, although the manager terminal 30 is disclosed as being singular, it is not limited thereto and may be configured in plurality.

According to an embodiment, the manager terminal 30 may recognize the situation of the livestock stall control device 10 using the determination result data.

According to the embodiment, the manager terminal 30 may monitor data transmitted and received between the livestock stall control device 10 and the livestock management server 20 in real time through a screen, thereby quickly recognizing the situation of the livestock stall control device 10 and rapidly dealing with a current condition.

According to an embodiment, the manager terminal 30 may learn the standard livestock stall management data received from the livestock management server 20, compare and analyze the livestock image data, and generate determination result data.

According to an embodiment, when the manager terminal 30 receives the determination result data generated by the livestock management server 20, the manager terminal 30 may generate a feedback signal corresponding to the determination result data to transmit the generated feedback signal to the livestock management server 20 or the livestock stall control device 10. For example, the manager terminal 30 may determine an abnormal symptom of the livestock as a disease symptom, a birthing symptom, or a mounting symptom. Accordingly, the manager terminal 30 may generate a feedback signal corresponding to each abnormal symptom.

According to an embodiment, the manager terminal 30 may receive a feedback signal generated in response to the determination result data from the livestock management server 20.

According to an embodiment, the manager terminal 30 may generate livestock image data by using the image information and/or sensing information received from the livestock stall control device 10.

The operation of the smart livestock management system according to an embodiment of the inventive concept having the above-described structure will be described as follows. Although the smart livestock management method has been disclosed as being performed in the livestock management server 20, the inventive concept is not limited thereto.

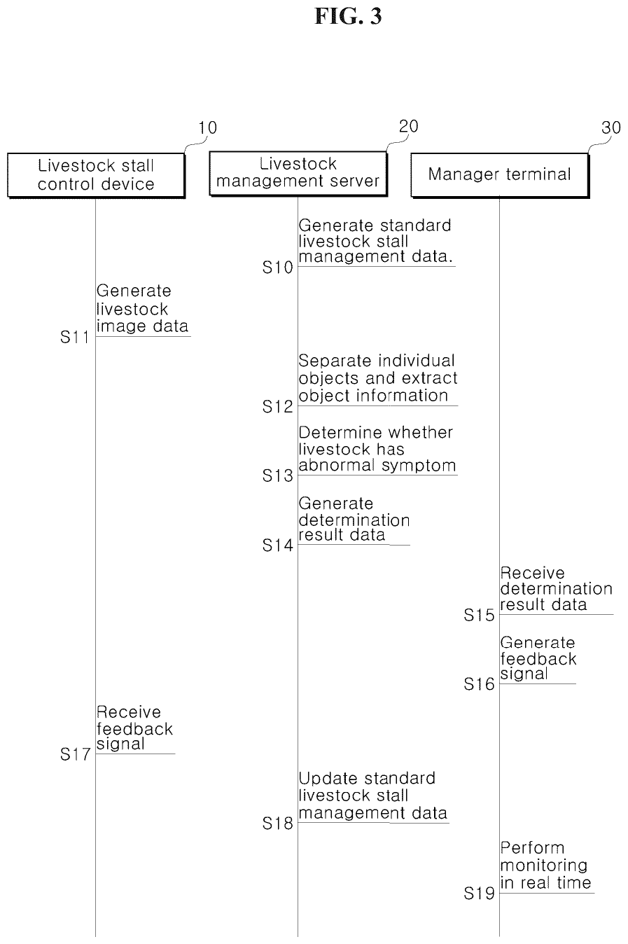

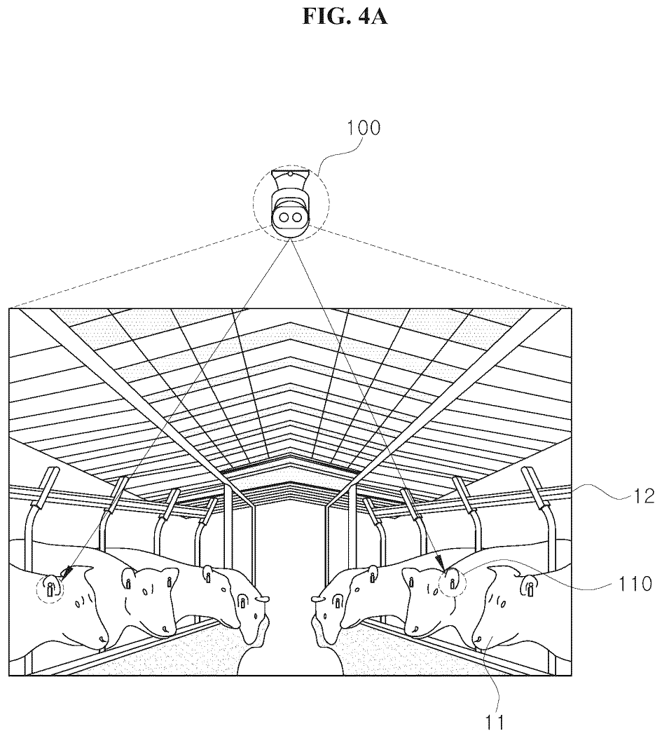

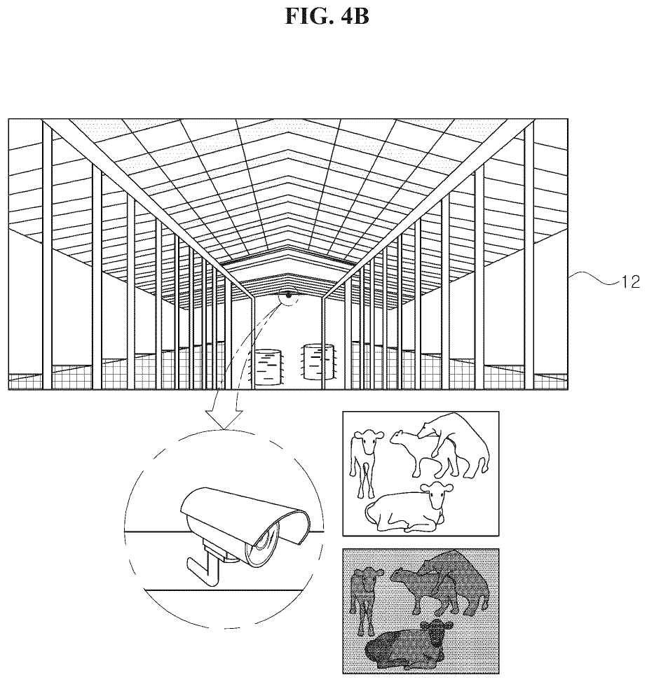

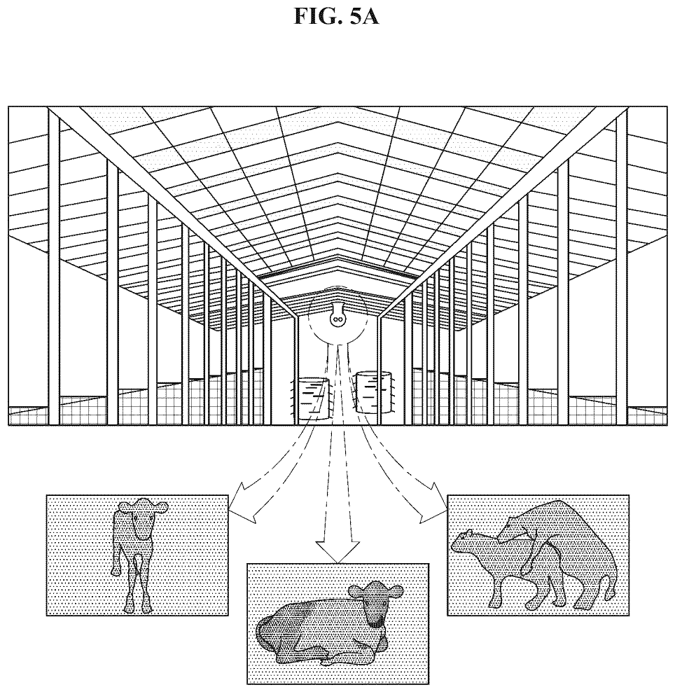

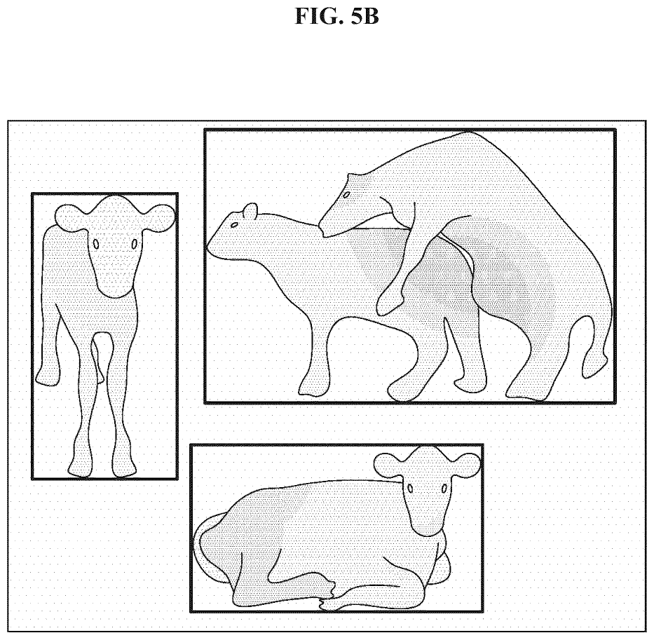

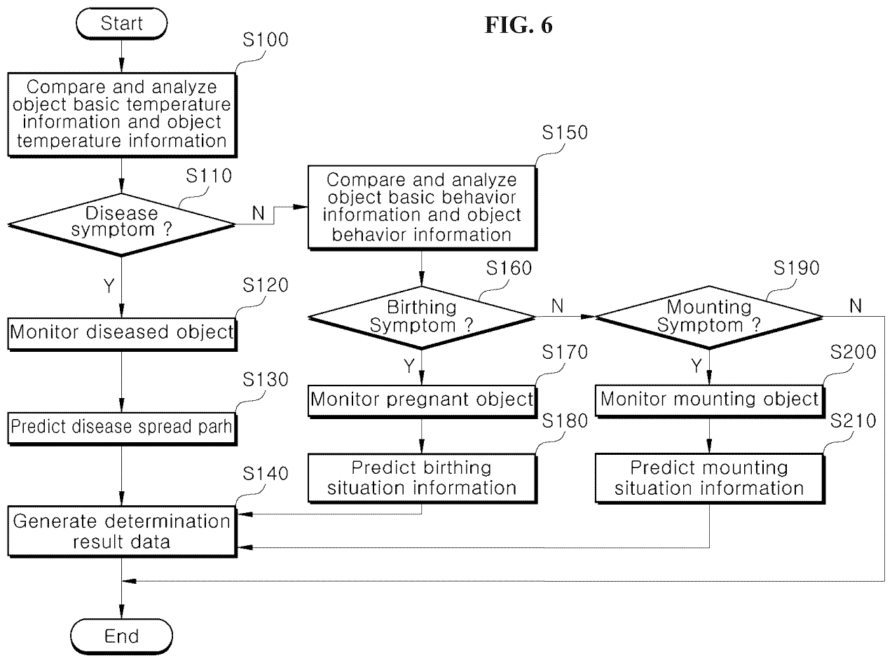

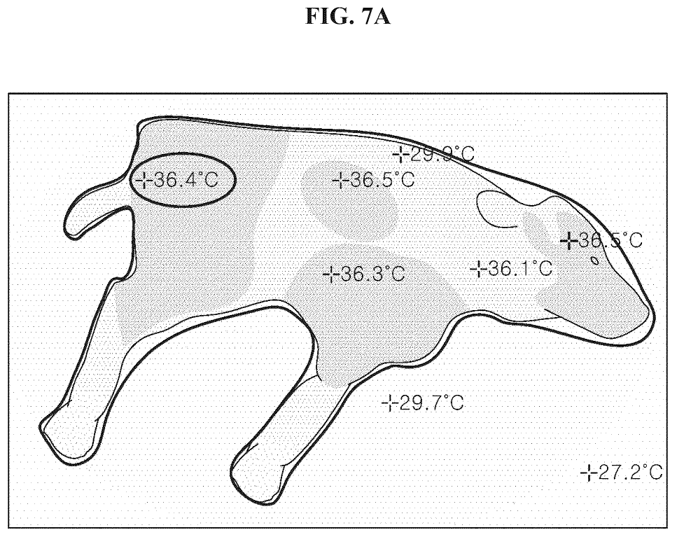

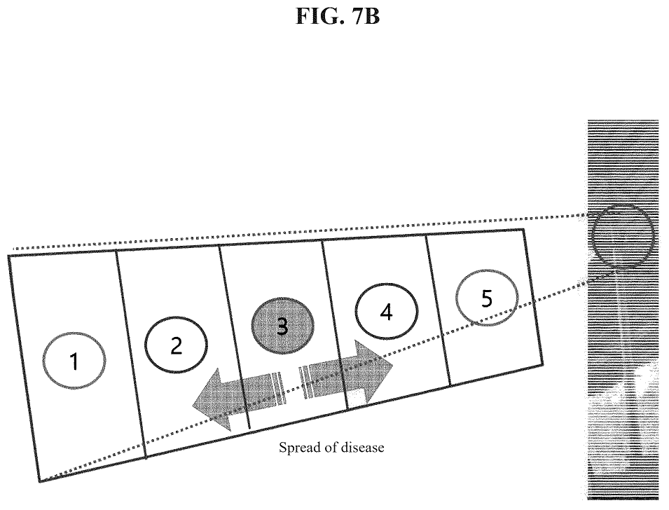

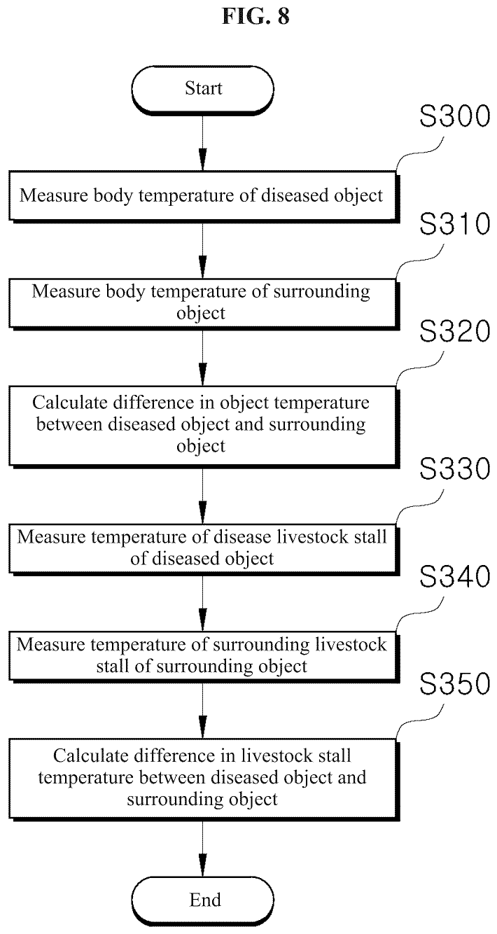

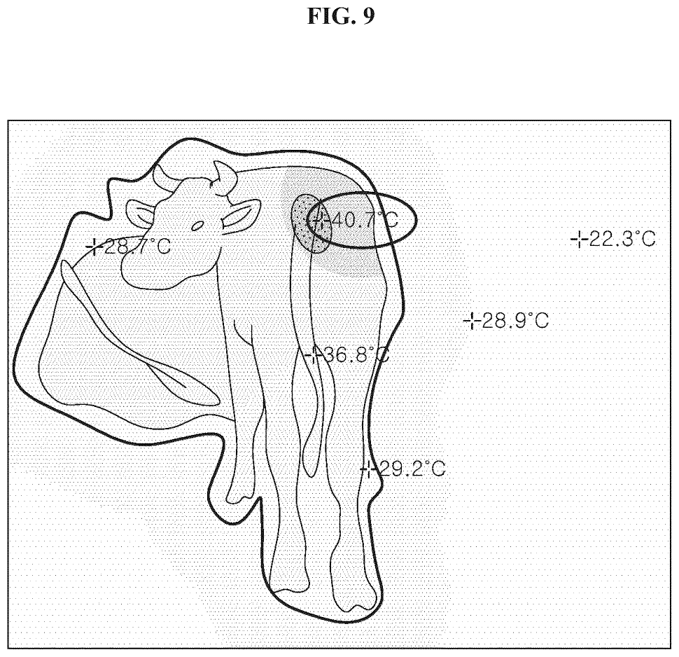

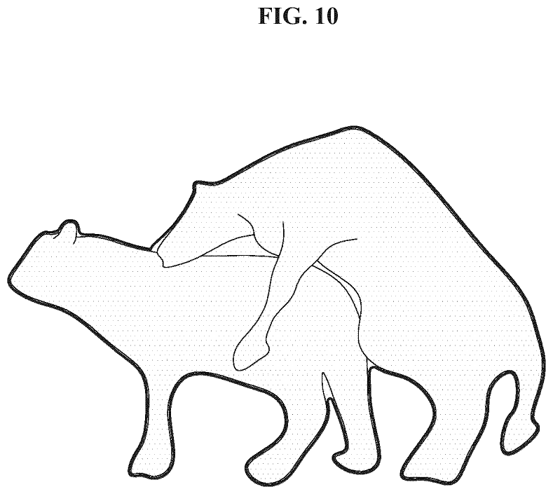

FIG. 3 is a diagram for describing a smart livestock management method according to an embodiment of the inventive concept, FIGS. 4A and 4B are diagrams for describing a method of generating livestock image data shown in FIG. 3, FIGS. 5A and 5B are diagrams for describing a method of separating objects and extracting object information shown in FIG. 3, FIG. 6 is a detailed view for describing a step of generating determination result data shown in FIG. 3, FIGS. 7A and 7B are diagrams for describing an embodiment for determining an abnormality of livestock shown in FIG. 6 as a disease symptom, FIG. 8 is a detailed view for describing a step of predicting a disease spread path shown in FIG. 6, FIG. 9 is a view for describing an embodiment of determining an abnormality of livestock shown in FIG. 6 as a birthing symptom, and FIG. 10 is a view for describing an embodiment of determining an abnormality of livestock shown in FIG. 6 as a mounting symptom.

First, as shown in FIG. 3, the livestock management server 20 may generate standard livestock stall management data (S10).

Specifically, the livestock management server 20 may generate the standard livestock stall management data by repeatedly learning object information extracted from livestock image data. Here, the standard livestock stall management data may include object basic temperature generated by repeatedly learning the highest body temperature information and lowest body temperature information of a normal livestock and a surrounding livestock of the normal livestock and livestock stall basic temperature information generated by repeating learning the highest temperature information and the lowest temperature information of a normal livestock stall and a surrounding livestock stall of the normal livestock stall, but is not limited thereto.

Next, the livestock stall control device 10 may generate the livestock image data by photographing the livestock 11 located in the livestock stall 12.

For example, as shown in FIGS. 4A and 4B, the livestock stall control device 10 may generate the livestock image data by performing conversion on image information obtained by photographing a plurality of livestock 11 having the identification tag 110 attached and surrounding environment of livestock stalls 12 in which the plurality of livestock 11 are located.

On the other hand, the livestock stall control device 10 may generate the livestock image data by converting the image information and the sensor information acquired from the sensor unit 120. In this case, the livestock image data may include current situation information including real-time weather information, season information, time information, or the like.

Next, the livestock management server 20 may separate a plurality of livestock 11 included in the livestock image data received from the livestock stall control device 10 into individual objects, and extract object information for each object (S12).

For example, as shown in FIGS. 5A and 5B, the livestock management server 20 may separate the plurality of livestock 11 into individual objects using the identification tag 110, but is not limited thereto.

Next, the livestock management server 20 may generate determination result data by determining whether an object has an abnormal symptom by using a result of analysis of the livestock image data based on the standard livestock stall management data (S13 and S14).

Specifically, referring to FIG. 6, the livestock management server 20 may perform comparison and analysis by matching object body temperature information of object information included in the livestock image data and object basic temperature information included in the standard livestock stall management data and matching object behavior information of the object information included in the livestock image data and object basic behavior information included in the standard livestock stall management data (S100) and determine an abnormal symptom as a disease symptom (S110). For example, when the object temperature is higher or lower than the object basic temperature information and the object behavior information indicates that there is no movement, the livestock management server 20 may determine an abnormal symptom as a disease symptom for a corresponding object.

Next, when the determination result indicates a disease symptom, the livestock management server 20 may monitor the object body temperature information of a diseased object as shown in FIGS. 7A and 7B (S120), and predict a disease spread path related to the diseased object and generate the determination result data (S130 and S140).

For example, as a result of monitoring, when the diseased object of FIG. 7A is located in (3) of FIG. 7B, it is possible to predict the disease spread path as to whether a disease spreads in the order of 3>2>1 or 5>4>3 by using the object information of the diseased object, object information of a surrounding object of the diseased object, livestock stall information in which the diseased object is located, and livestock stall information in which the surrounding object of the diseased object is located.

More specifically, referring to FIG. 8, the livestock management server 20 may measure a body temperature of the diseased object to calculate first object temperature information (S300), and measure body temperature of the surrounding object of the diseased object to calculate second object temperature Information (S310).

Next, the livestock management server 20 may calculate a difference in object temperature between the calculated first object temperature information and the calculated second object temperature information to generate a first temperature difference (S320).

Next, the livestock management server 20 may calculate first livestock stall temperature information by measuring a temperature of a disease livestock stall where the diseased object is located (S330), and calculate second livestock stall temperature information by measuring a temperature of a surrounding livestock stall where the surrounding object is located (S340).

Next, the livestock management server 20 may generate a second temperature difference by calculating a difference between the calculated first livestock stall temperature information and the second livestock stall temperature information (S350).

Accordingly, the livestock management server 20 may predict a disease spread path in consideration of the calculated object temperature difference and the calculated livestock stall temperature difference.

On the other hand, when the abnormal symptom is not determined as a disease symptom as a result of performing comparison and analysis by matching the object body temperature information of the object information included in the livestock image data with the object basic temperature information included in the standard livestock stall management data with respect to the object (S100), the livestock management server 20 may compare and analyze the object body temperature information of object information included in the livestock image data and the object basic temperature information included in the standard livestock stall management data and compare and analyze the object behavior information of the object information included in the livestock image data and the object basic behavior information included in the standard livestock stall management data and as a result of the comparison and analysis, determine the abnormal symptom as a birthing symptom (S150 and S160). For example, when the object temperature is lower than the object basic temperature information, and the object behavior information indicates a behavior pattern representative of birthing learned by deep learning technique, the livestock management server 20 may determine the abnormal symptom of the object as the birthing symptom.

Next, when the determination result indicates the birthing symptom, the livestock management server 20 may monitor the object behavior information of a pregnant object as shown in FIG. 9 (S170), and predict birthing situation information of the pregnant object and generate the determination result data (S180).

In addition, the livestock management server 20 may determine a mounting symptom when the determination result indicates that the abnormal symptom is not the birthing symptom (S190). That is, the livestock management server 20 may determine the abnormal symptom as a mounting symptom as a result of comparing and analyzing the object body temperature information of the object information included in the livestock image data and the object basic temperature information included in the standard livestock stall management data and comparing and analyzing the object behavior information of the object information included in the livestock image data and the object basic behavior information included in the standard livestock stall management data.

For example, when the object temperature is higher than the object basic temperature information, and the object behavior information indicates a behavior pattern representative of mounting learned by deep learning technique, the livestock management server 20 may determine the abnormal symptom of the object as the mounting symptom.

Next, when the determination result indicates the mounting symptom, the livestock management server 20 may monitor mounting behavior information for a mounting object as shown in FIG. 10 (S200), and predict mounting situation information of the mounting object and generate the determination result data (S210).

Next, the livestock management server 20 may transmit the generated determination result data to the manager terminal 30 (S15).

Subsequently, the manager terminal 30 receiving the determination result data may generate a feedback signal corresponding to the determination result data (S16).

According to an embodiment, the manager terminal 30 may learn the standard livestock stall management data received from the livestock management server 20, compare and analyze the livestock image data, and generate determination result data.

According to an embodiment, the feedback signal may be generated by the livestock management server 20.

Next, the livestock stall control device 10 may receive the feedback signal and control the livestock stall control device 10 (S17).

Next, the livestock management server 20 may update the standard livestock stall management data in real time in response to the determination result data (S18).

Finally, the manager terminal 30 may monitor the livestock stall control device 10 and the livestock management server 20 in real time.

For example, when the abnormal symptom of the object is a disease symptom, the manager terminal 30 may receive a disease spread path updated in real time.

In addition, when the abnormal symptom of the object is a birthing symptom, the manager terminal 30 may receive birthing situation information updated in real time.

In addition, when the abnormal symptom of the object is a mounting symptom, the manager terminal 30 may receive mounting situation information updated in real time.

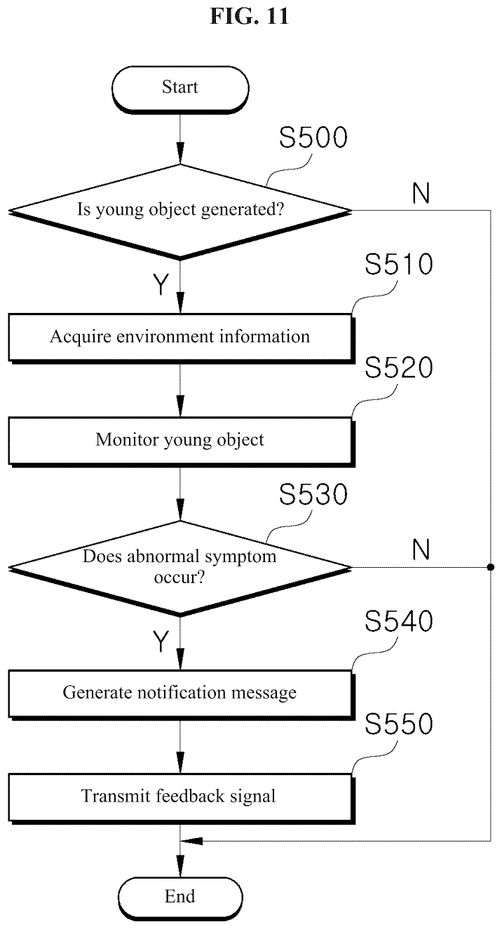

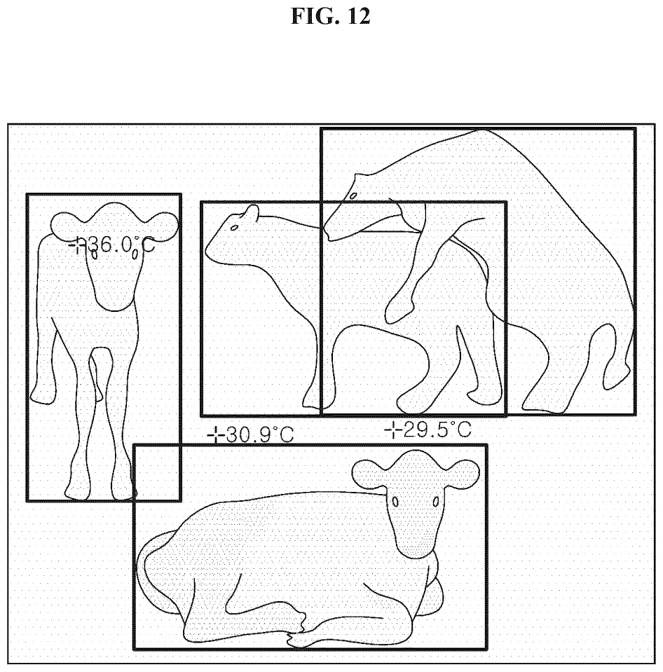

FIG. 11 is a view for describing a smart livestock management method according to another embodiment of the inventive concept, and FIG. 12 is a diagram for describing a case in which a young object shown in FIG. 11 is generated. Referring to FIG. 11, when a young object (young object) is generated due to the birthing of a pregnant object (mother object) (S500), the livestock management server 20 may monitor the young object in consideration of environment information (S510 and S520).

Next, when an abnormal symptom occurs in the young object (S530), the livestock management server 20 may transmit a notification message to the manager terminal 30 (S540).

Finally, the livestock management server 20 may receive a feedback signal for the notification message and transmit the feedback signal to the livestock stall control device 10 (S550).

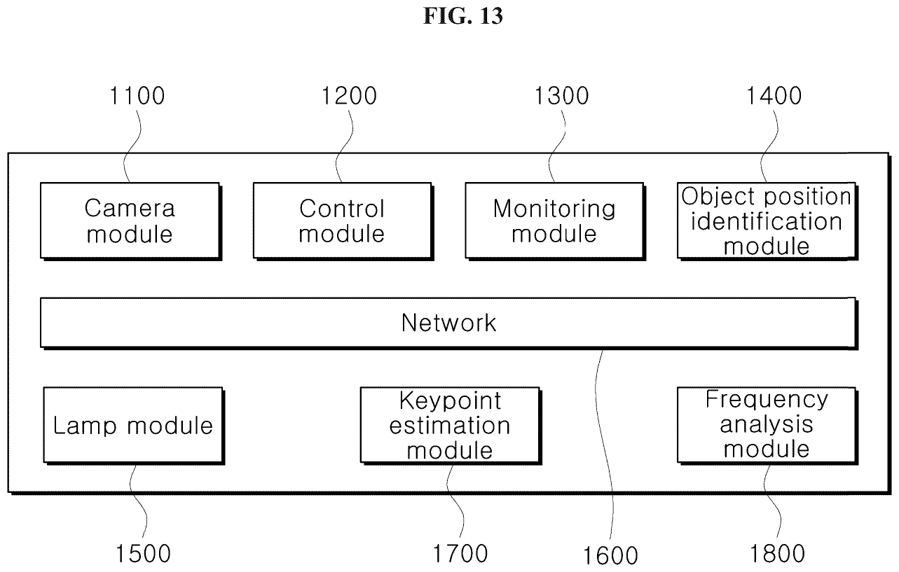

FIG. 13 is a diagram showing an overall configuration of a vision recognition-based cattle object flipping detection device according to an embodiment of the present disclosure.

Referring to FIG. 13, the device may include a camera module 1100, a control module 1200, a monitoring module 1300, an object position identification module 1400, a lamp module 1500, a network 1600, a keypoint estimation module 1700, and a frequency analysis module 1800.

The camera module 1100 is a device that monitors a cattle object inside a livestock shed and acquires a first image, and may include a general image camera and/or a thermal imaging camera. The general image camera preferably has a resolution of 1920×1080 pixels (Full HD) or higher, but is not limited thereto, and may acquire an image at a frame rate of 30 frames per second or higher. The thermal imaging camera may have a resolution of 640×480 pixels or more and a temperature resolution of 0.05° C. or less, and may detect infrared rays in a predetermined wavelength band, for example, a wavelength band of 8 to 14 μm, to visualize the body temperature distribution of cattle.

The camera module 1100 may be configured as a top-view method installed on the ceiling of a barn to shoot vertically downwards, and a side-view method installed on the wall of a barn to shoot horizontally. The top-view camera may be installed at a predetermined height from the ceiling of a barn to monitor the floor area, and the side-view camera may be installed at a predetermined height from the wall of a barn to detect cattle objects within the monitoring range.

The camera module 1100 may have a waterproof and dustproof function of an IP67 rating or higher, and may be designed to be durable against dust, moisture, ammonia gas, and the like in a barn environment. In addition, the camera module 1100 may operate stably in a temperature range of −20° C. to 60° C., and may operate based on IR lighting for night photography, for example, an 850 nm wavelength.

The control module 1200 performs an operation of detecting a flipping state of a cattle object based on vision recognition according to the present disclosure, performs an operation of controlling components of the present device, and analyzes the first image received from the camera module 1100 to add a display object for the cattle object to generate a second image. At this time, the display object may include a boundary mark and state information of the cattle object identified in the first image.

The control module 1200 may include, but is not limited to, a hardware processor including, for example, a quad-core 2.0 GHz or higher CPU, 8 GB or higher RAM, 256 GB or higher storage space, and a GPU of NVIDIA Jetson Xavier NXTM or higher or an AI accelerator with equivalent performance.

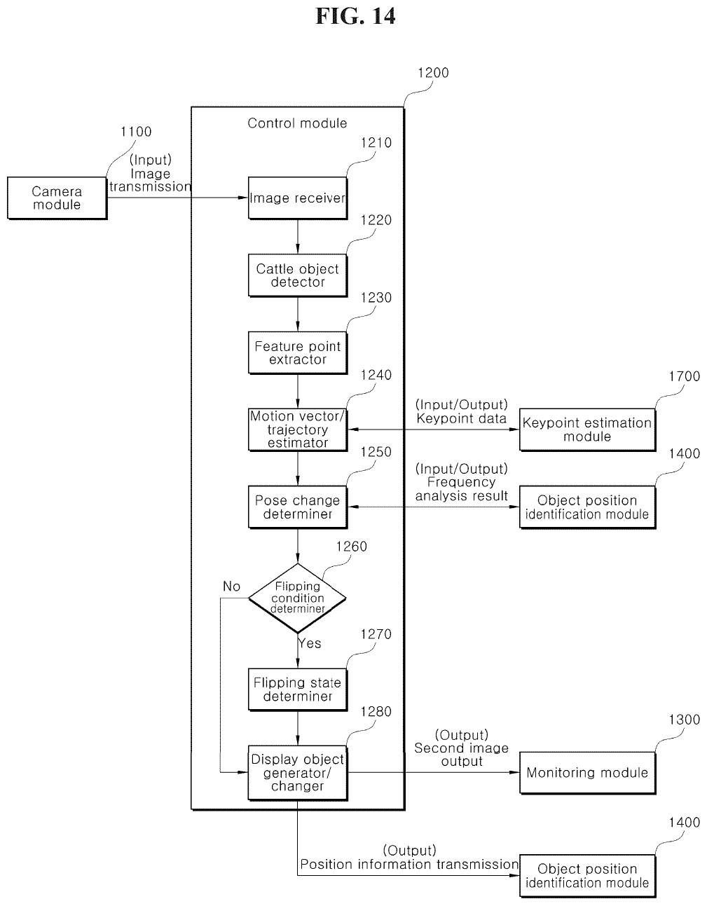

The control module 1200 may operate based on the Linux operating system, and may perform image processing and deep learning-based analysis using libraries such as OpenCV 4.5 or higher, TensorFlow 2.5 or higher, and PyTorch 1.8 or higher, but is not limited thereto, and the specifications may be changed as needed. In addition, real-time image processing through GPU acceleration may be possible by supporting CUDA 11.0 or higher. The detailed configuration and processing flow of the control module 1200 are described in detail with reference to FIG. 14.

The monitoring module 1300 is a device that receives the second image from the control module 1200 and outputs a real-time monitoring image, and the monitoring module 1300 may include a display of 24 inches or larger, a resolution of 1920×1080 pixels or larger, and a touchscreen function, but is not limited thereto. In addition, the monitoring module may provide audiovisual notifications including a speaker system capable of generating a warning sound of 85 dB or more and an LED warning light.

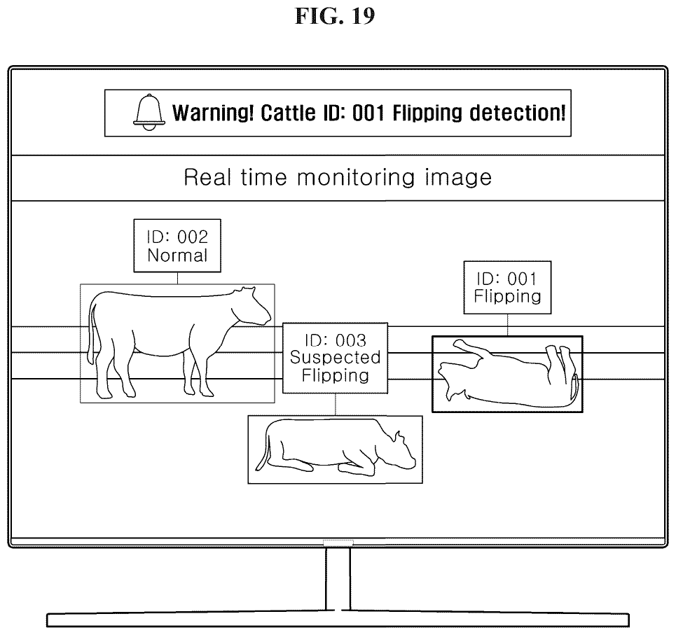

The monitoring module 1300 is implemented as a web-based interface and may be accessed from various devices such as PCs, tablets, and smartphones. The interface may include a real-time video monitoring screen, a livestock house plan screen, a notification log screen, and a statistics and report screen, and accessible functions may be differentiated according to user authority. The detailed screen configuration of the monitoring module 1300 is described in detail with reference to FIG. 19.

The object position identification module 1400 may identify the position of the cattle object in a livestock house determined to be in a flipping state by the control module 1200 and transmit the position to the monitoring module 1300. The object position identification module 1400 may include a livestock house plan database, camera calibration information, and a coordinate conversion algorithm. The livestock house plan is divided into grids of a predetermined resolution, and each grid may be assigned a unique ID.

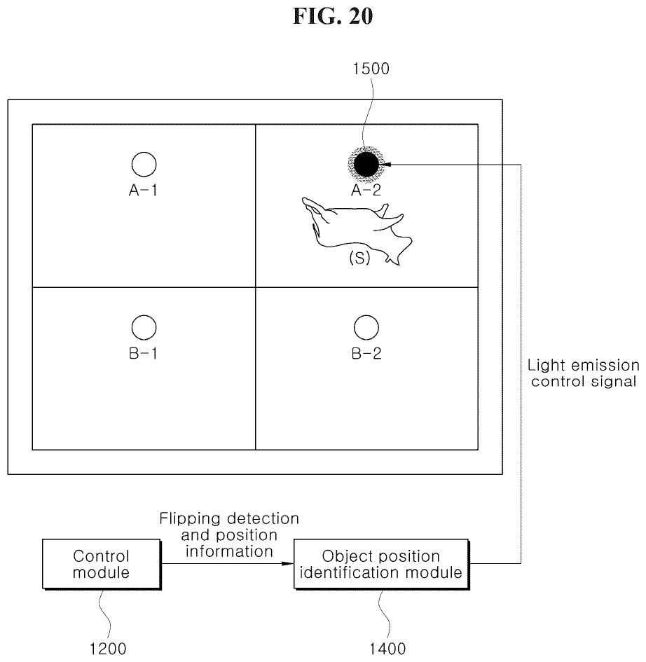

The object position identification module 1400 may use a homography transformation matrix to convert the pixel coordinates of the cattle object in a camera image into actual physical coordinates (x, y, z) in a barn. In a multi-camera environment, the triangulation method may be additionally applied to improve the accuracy within a certain range. The detailed operation of the object position identification module 1400 will be described later with reference to FIG. 20.

The lamp module 1500 receives position information from the object position identification module 1400 and emits light in the corresponding section. The lamp module 1500 may be installed at a certain position for each of a plurality of sections in the barn. The lamp module 1500 may be displayed in a non-lit state in a normal state, and may blink in a certain pattern when a flipping state is detected to visually notify an emergency. Each lamp module may have an independent battery. The detailed specifications and operation of the lamp module 1500 will be described in detail with reference to FIG. 20.

Meanwhile, the control module 1200 may control the lamp module 1500 placed in a section corresponding to the position of the cattle object identified by the object position identification module 1400 among the plurality sections to emit light.

The network 1600 may provide a wired or wireless network for data communication between each module. The wired network may be based on Gigabit Ethernet (1000BASE-T), but is not limited thereto, and may be used for large-capacity image data transmission between the camera module 1100 and the control module 1200. The wireless network may be used by mixing Wi-Fi 6 (IEEE 802.11ax, up to 9.6 Gbps) and Zigbee (IEEE 802.15.4, 250 kbps), but is not limited thereto. The Wi-Fi network is used for communication between the monitoring module 1300 and the control module 1200, and may support 2.4 GHz and 5 GHZ dual bands. The Zigbee network may be used for communication between the lamp module 1500 and the control module 200 because it is capable of low-power, long-distance communication. The Zigbee network is configured with a mesh topology, and may provide stable communication up to a distance of 100 m, and may connect up to 65,000 devices to one network.

The keypoint estimation module 1700 is a device that estimates keypoints of a body and a leg of the cattle object. The keypoint estimation module 1700 may use a deep learning-based pose estimation algorithm, and may be based on an architecture such as HRNet (High-Resolution Network) or OpenPose, but is not limited thereto. A predetermined number of keypoints may be estimated per cattle object.

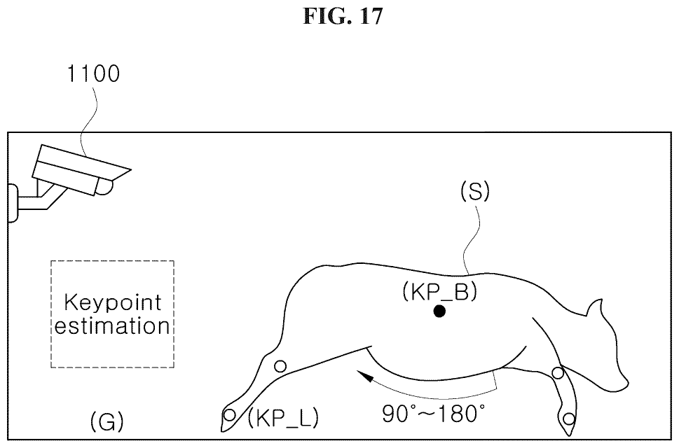

The keypoint estimation module 1700 may be trained with multiple cattle objects or livestock shooting images and labeled keypoint data, and may be set to have an average IoU Intersection over Union of 0.85 or higher and an accuracy of PCK (Percentage of Correct Keypoints) of 0.9 or higher, but is not limited thereto. Keypoint estimation may be processed in real time at a speed of a certain frame per second or higher, and for example, a Kalman filter may be applied to maintain temporal consistency. The detailed operation of the keypoint estimation module 700 is described in detail with reference to FIG. 17.

The frequency analysis module 1800 may analyze a temporal sequence of a movement vector in a frequency domain to determine whether the flipping condition is satisfied. The frequency analysis module 800 may convert a signal in the time domain into the frequency domain using an FFT (Fast Fourier Transform) or DWT (Discrete Wavelet Transform) algorithm. The FFT may be set to a window size of 64 frames (approximately 2.13 seconds) and 50% overlap, but is not limited thereto, and may analyze frequency components according to a given range in a video of 30 frames per second, which is a typical setting condition.

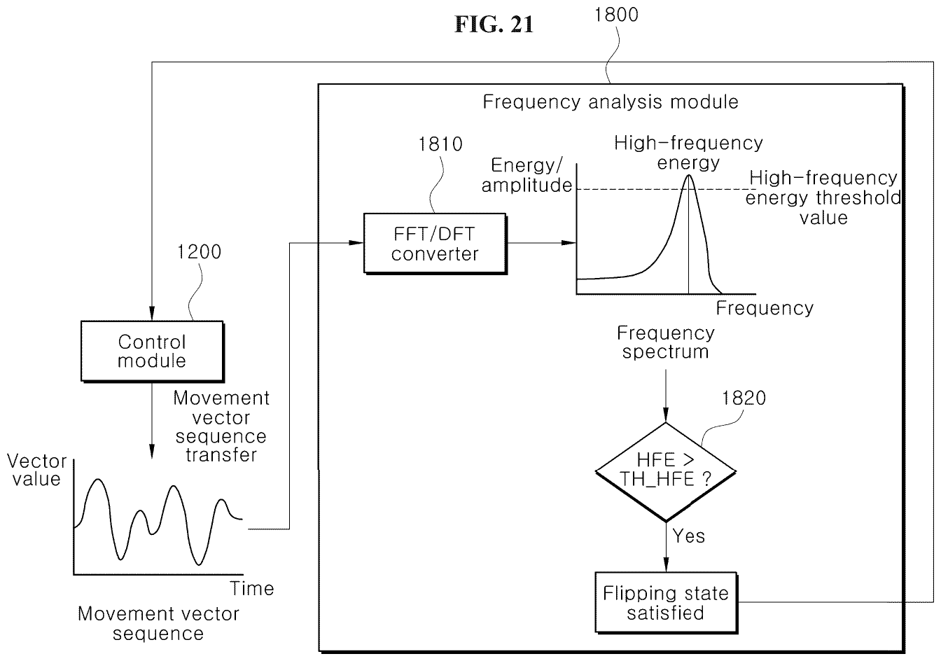

The frequency analysis module 1800 includes a frequency feature database for a movement pattern of cattle in a normal state and cattle in a flipping state. While cattle in the normal state is mainly dominated by low-frequency components in the range of 0 to 3 Hz, cattle in the flipping state may show features of increasing high-frequency components of 8 Hz or higher. The high-frequency energy threshold TH_HFE may be set to a predetermined range of the total energy, for example, when 35% or more is concentrated in a frequency band of 8 Hz or higher, but is not limited thereto, and the detailed operation method of the frequency analysis module 800 will be described later with reference to FIG. 21.

FIG. 14 is a detailed processing flowchart of a control module according to an embodiment of the present disclosure.

Referring to FIG. 14, the control module 1200 may include an image receiver 1210, a cattle object detector 1220, a feature point extractor 1230, a motion vector/trajectory estimator 1240, a pose change determiner 1250, a flipping condition determiner 1260, a flipping state determiner 1270, and a display object generator/changer 1280.

The image receiver 1210 may receive the first image from the camera module 1100. The image receiver 1210 may receive a video stream compressed with an H.264 or H.265 codec via RTSP (Real Time Streaming Protocol) or RTMP (Real Time Messaging Protocol), but is not limited thereto. The received image may be converted into a frame in RGB or YUV format through a decoding process, and may undergo preprocessing processes such as resolution adjustment typically 640×480 or 1280×720 pixels, noise removal Gaussian filter, kernel size 5×5, standard deviation 1.0, and contrast enhancement histogram equalization as needed, but are not limited thereto.

The cattle object detector 1220 identifies the cattle object in the received image and generates the boundary mark. The cattle object detector 1220 uses a deep learning-based object detection algorithm such as YOLOv7 or Faster R-CNN. The YOLOv7 model may use CSPDarknet53 as a backbone, and the input image size may be set to 640×640 pixels, the number of anchor boxes may be 3, the IoU threshold may be set to 0.5, and the confidence threshold may be set to 0.4, but are not limited thereto.

The cattle object detector 1220 is trained with a predetermined number or more of cattle object shooting images, and cattle object detection may be processed in real time at a speed of 25 frames per second or more, but is not limited thereto, and may output bounding box information including the upper left x-axis coordinate, y-axis coordinate, width, and height for each cattle object, and a confidence score having a value between 0 and 1. In addition, for individual identification of the cattle object, for example, a ReID (Re-Identification) algorithm may be applied to assign a unique ID to each cattle object and perform frame-to-frame tracking, but is not limited thereto.

The feature extractor 1230 may extract a feature point from the identified cattle object. The feature extractor 1230 may extract the feature point using at least one of SIFT (Scale-Invariant Feature Transform), SURF (Speeded-Up Robust Features), and ORB (Oriented FAST and Rotated BRIEF) algorithms, but is not limited thereto. In this embodiment, the ORB algorithm with high computational efficiency is used as a basic example, but it is not limited thereto, and a minimum of 30 and a maximum of 100 feature points may be extracted for each cattle object.

The ORB algorithm is a method that combines the FAST corner detector and the BRIEF descriptor, and the FAST parameter for feature point detection may be set to enable threshold non-maximal suppression. The extracted feature point may be expressed as a binary descriptor with a length of 32 bytes, and the principal orientation may be calculated for rotational invariance. The feature point extraction may be performed only in the area inside the bounding box of the cattle object, thereby increasing computational efficiency.

The motion vector/trajectory estimator 1240 may calculate the motion vector of the feature point and calculate the motion trajectory of the cattle object. The motion vector/trajectory estimator 1240 may use a brute force matching algorithm based on the Hamming Distance to match the feature point extracted from consecutive frames. The matching threshold may be set to 50, and the ratio test threshold may be set to 0.75, but is not limited thereto.

The motion vector is calculated as the position difference between the matched feature point pairs, and may be expressed as a vector V(t)=P(t)−P(t−1) (where P is the 2D coordinate) of the feature point. The magnitude and orientation of the motion vector are calculated, and the RANSAC (Random Sample Consensus) algorithm may be applied to remove outliers. The RANSAC parameters may be set to the number of repetitions 100 and the threshold 3.0 pixels, but are not limited thereto.

The movement trajectory is calculated by accumulating the movement vector over time, and a predetermined setting value, for example, a movement vector history of 90 frames, may be maintained. The movement trajectory is calculated based on the center point of the cattle object, and the center point may be defined as the median of the feature points. A moving average filter window size 5 may be applied to smooth the movement trajectory, but is not limited thereto.

The posture change determiner 1250 may determine the posture change of the cattle object by analyzing the numerical change of the movement trajectory. The posture change determiner 1250 may calculate numerical values such as speed, acceleration, inclination, and direction from the movement trajectory. The speed may be calculated as a value obtained by dividing the displacement between consecutive frames by time (pixels/frame), and the acceleration may be calculated as a rate of change of speed (pixels/frame²).

The inclination may be calculated as the angle between the principal axis of the movement trajectory and the horizontal line (e.g., the ground where the cattle object in the barn is located), and the principal axis may be determined through principal component analysis (PCA) on the covariance matrix of the feature point distribution. The direction may be calculated as the angle (radians or degrees) of the movement vector between consecutive frames, and the direction change may be calculated as the angular difference between consecutive movement vectors.

The posture change determiner 1250 may analyze the movement of the cattle object within the boundary marker. For this purpose, the optical flow algorithm may be used, and in this embodiment, the Farneback algorithm with high computational efficiency may be used. The parameters of the Farneback algorithm may be set to pyramid level 3, window size 15, number of iterations 3, polynomial expansion degree 5, and standard deviation 1.2, but are not limited thereto.

The optical flow may be calculated only in the area inside the bounding box of the cattle object, and the movement vector (u, v) for each pixel may be derived. The magnitude of the movement vector may be calculated as sqrt (u2+v2), and statistics such as the average magnitude, median, standard deviation, and maximum of the entire movement vector may be calculated. These statistics may be used to quantify the degree of movement inside the cattle object.

The flipping condition determiner 1260 may determine whether the attitude change satisfies the flipping condition. The flipping condition may be defined as a case where the numerical change of the movement trajectory is less than or equal to a first threshold value, and the movement within the boundary mark of the cattle object is greater than or equal to a second threshold value. The first threshold value TH1 may be set to 0.03 pixels/frame² for the velocity change of the movement trajectory, and 5°/frame for the direction change.

The second threshold value TH2 may be set to 0.8 pixels/frame for the average size of the optical flow vector. This may be determined as a characteristic of a flipping state when the movement of the entire cattle object is small (below the first threshold value) but there is active movement internally (above the second threshold value). The flipping condition determination may be expressed as a logical operation (Movement trajectory numerical change <TH1 AND Movement within boundary mark >TH2).

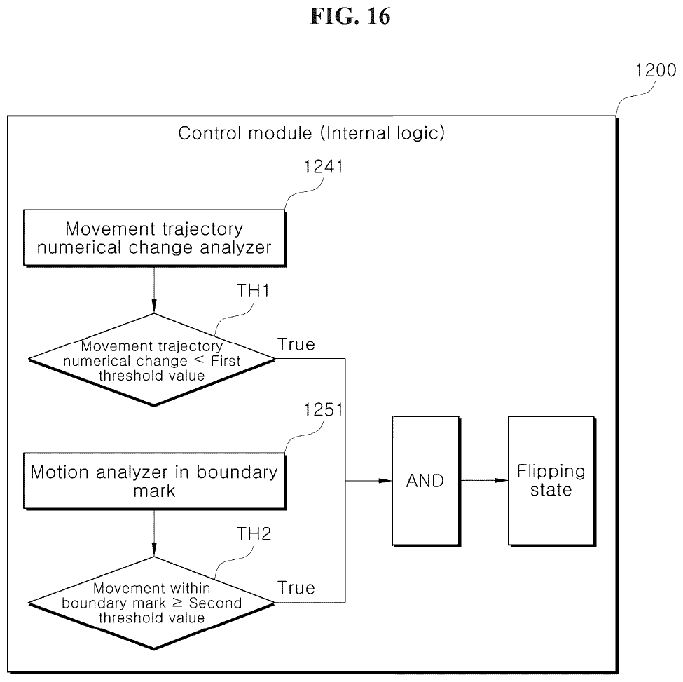

In addition, when the high-frequency energy analysis result received from the frequency analysis module 1800 exceeds the threshold value, it may also be determined as the flipping condition. In this case, the flipping condition may be expressed as a logical operation (Movement trajectory numerical change <TH1 AND Movement within boundary mark >TH2 OR High-frequency energy >TH_HFE). The detailed logic of the flipping condition determiner 1260 is described in detail in FIG. 16.

The flipping state determiner 1270 may determine the state of the cattle as a ‘flipping state’ when the flipping condition is satisfied. The flipping state determiner 1270 may check whether the flipping condition is continuously satisfied for a preset time to prevent false detection. In the present embodiment, for example, when the flipping condition is continuously satisfied for at least 3 seconds 90 frames, the state may be determined as the flipping state.

In addition, when the posture analysis result received from the keypoint estimation module 1700 is set as a flipping candidate state and the movement index (MI) is maintained below a threshold value (0.5 pixels/frame) for a preset duration 15 seconds, the state may be determined as a flipping state. The flipping state may be divided into three stages: ‘Suspected’, ‘Confirmed’, and ‘Emergency’, and different notification methods may be applied to each stage.

The display object generator/changer 1280 generates a display object for the cattle object in an image, and may change state information when in the flipping state. The display object may include a boundary mark (bounding box) of the cattle object and state information(text or icon). The boundary mark indicates a bounding box of the cattle object, and may be defined by upper left coordinates (x, y), width (w), and height (h).

The state information indicates the current state of the cattle object, and may be classified into ‘Normal’, ‘Suspected Flipping’, ‘Confirmed Flipping’, and ‘Emergency Flipping’. Each state may be displayed with a different color code for example, Normal: Green #00FF00, Suspected: Yellow #FFFF00, Confirmed: Orange #FF8000, Emergency: Red #FF0000. In addition, additional information such as the ID of the cattle object, duration of the flipping state, and position information may also be displayed.

The display object generator/changer 1280 may create the second image by adding a display object to the first image. The second image may be transmitted to the monitoring module 1300 in the form of a bounding box, state text, movement trajectory, keypoint, and the like being overlaid on the original image, and may provide visual information to the operator. The generation cycle of the second image is, for example, 15 frames per second or more, so that real-time monitoring may be possible.

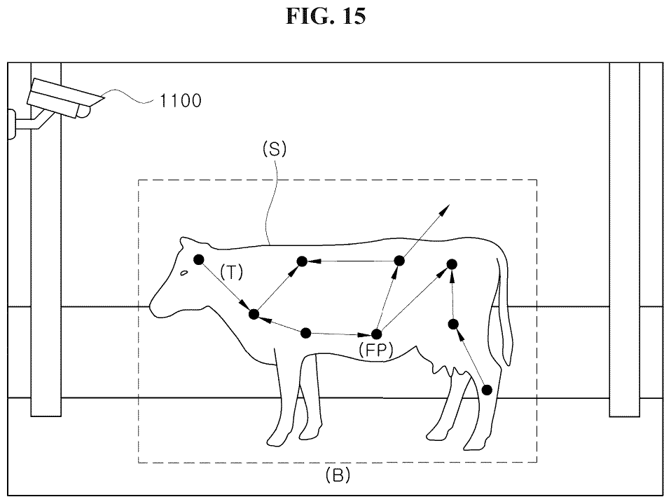

FIG. 15 is a diagram showing an example of feature point extraction and movement trajectory calculation according to an embodiment of the present disclosure.

Referring to FIG. 15, the cattle object S is detected in an image acquired by the camera module 1100, and key feature points FPs may be extracted within the cattle object S. The feature points FPs may be selected as points useful for tracking the movement of the cattle object S, such as the main joints and the center of the body.

The feature points FPs may be extracted from areas with rich texture and easy distinction within the cattle object S, and may generally be concentrated on the head, shoulders, hips, and leg joints of the cattle. The feature points may be displayed as small circles or crosses in the image, and each feature point may be given a unique ID so that tracking between frames may be possible. The size of the feature point may be set to 3 to 5 pixels, and the color may be displayed differently depending on the state of the feature point (newly detected feature point: green, feature point being tracked: blue, feature point at risk of tracking failure: yellow).

The movement path of the feature point FP over time may be expressed as a movement trajectory T. The movement trajectory T is a form in which the positions of the same feature point in consecutive frames are connected by lines, and may visualize the movement pattern of the cattle object S. The movement trajectory may maintain a history of, for example, up to 90 frames (approximately 3 seconds), and may be displayed as a gradient whose color changes over time (latest: red, past: blue).

The boundary mark B surrounding the cattle object S may be expressed in the form of a bounding box, and may indicate the position and size of the cattle object. The bounding box may be set to include the outermost boundary of the cattle object, and the padding may be set to 10% of the size of the cattle object. For example, the line thickness of the bounding box is 2 to 3 pixels, and the color may be displayed differently depending on the state of the cattle object (normal: green, suspected of flipping: yellow, confirmed of flipping: red).

While the movement of normal cattle shows a movement trajectory with a certain pattern, cattle in a flipping state may show a movement trajectory that is irregular or shows abrupt changes. While the cattle in a normal state has a smooth and continuous movement trajectory with gentle changes in direction, the cattle in a flipping state may show a sudden interruption in the movement trajectory, abrupt changes in direction, or an irregular zigzag pattern.

In addition, the cattle in a normal state shows consistency in which feature points move in a similar direction overall, while the cattle in a flipping state may show inconsistency in which feature points move in different directions. The state of the cattle may be determined by analyzing the difference in these movement patterns. The consistency of the feature point movement may be quantified by the direction dispersion of the feature point movement vector, and while the direction dispersion is 30° or less in the normal state, it may exhibit a high direction dispersion of 60° or more in the overturning state.

FIG. 16 is a diagram showing a flipping condition determination logic according to an embodiment of the present disclosure.

Referring to FIG. 16, the movement trajectory numerical change analyzer 241 in the control module 1200 may analyze the amount of change in at least one of speed, acceleration, inclination, and direction in the movement trajectory of the cattle object, and may determine whether the analyzed amount of change is less than or equal to the first threshold value TH1.

The movement trajectory numerical change analyzer 1241 may calculate various numerical changes in the movement trajectory. The speed change may be calculated as the absolute value of the speed difference between consecutive frames, and the threshold may be a predetermined setting value, for example, 0.03 pixels/frame². Acceleration may be calculated as the time derivative of the velocity change, and the threshold may be a predetermined setting value, for example, 0.01 pixels/frame³. The inclination change may be calculated as the absolute value of the inclination angle difference between consecutive frames, and the threshold may be 3°/frame. The direction change may be calculated as the absolute value of the angle difference between consecutive movement vectors, and the threshold may be 5°/frame.

The fact that the movement trajectory numerical change is less than the first threshold TH1 may mean that the overall movement of the cattle object is very small or almost non-existent. This may be because the cattle object is normally standing or lying down, or is in a state where it is flipped and unable to move. Therefore, this condition alone may not determine the flipping state, and additional conditions may be required.

The motion analyzer 1251 within the boundary mark may analyze the movement of pixels or feature points within the boundary mark of the cattle object. It may determine whether this movement is greater than or equal to the second threshold TH2. At least one of a motion vector field or an optical flow algorithm may be used for movement analysis.

The motion analyzer 1251 within the boundary mark may calculate a movement vector for each pixel within the cattle object using the Farneback optical flow algorithm. The magnitude of the movement vector may be calculated as sqrt (u²+v²), where u and v may be the movement amounts in the x-axis and y-axis directions, respectively. It may be determined whether the average magnitude of the entire movement vector is greater than or equal to 0.8 pixels/frame, which is the second threshold TH2.

The fact that the movement within the boundary mark is greater than or equal to the second threshold TH2 may mean that there is active movement within the cattle object. This may be a state in which the cattle is normally walking or running, or a state in which it has flipped and is struggling. Therefore, this condition alone may not determine the flipping state, and it may be determined in combination with the condition of the change in the movement trajectory value mentioned above.

AND gate/determination logic may logically determine whether both conditions (below the first threshold AND above the second threshold) are satisfied. When both conditions are satisfied, that is, when the overall movement of the cattle object is small but there is active movement internally, it may be determined as a flipping state. This may be logic for accurately capturing a situation where the cattle object falls and struggles in place.

The dual condition determination method according to the AND gate/determination logic may significantly reduce false detections compared to determination with only a single condition. For example, the state where the cattle object is normally standing or lying down (low change in movement trajectory value +low movement within the boundary marker) and the state where the cattle object is normally walking or running (high change in movement trajectory value+high movement within the boundary marker) may be clearly distinguished from the flipping state (low change in movement trajectory value+high movement within the boundary marker).

In addition, the analysis result of the frequency analysis module 1800 may be utilized as additional determination criteria. The frequency analysis module 1800 may analyze the time sequence of the movement vector in the frequency domain to determine whether the high-frequency energy exceeds the threshold value TH_HFE. In the case that this condition is satisfied, it may be determined as the flipping state through an OR gate.

Finally, the flipping state FS may be determined by the logical expression (Movement trajectory numerical change <TH1 AND Movement within boundary mark >TH2 OR High-frequency energy >TH_HFE). This multi-conditional determination method may comprehensively detect various flipping situations and reduce the false detection rate to 5% or less.

FIG. 17 is a diagram showing keypoint estimation and inclination analysis according to an embodiment of the present disclosure.

Referring to FIG. 17, a body keypoint KP_B and a leg keypoint KP_L of the cattle object S may be estimated from an image acquired by the camera module 1100.

The keypoint estimation module 1700 may estimate the main keypoint of the cattle object S using a deep learning-based pose estimation algorithm. The body keypoint KP_B may be located at a main part of the body, such as the head, neck, shoulder, back, waist, and hip of the cattle, for example, and may include a total of 9 keypoints (1 head, 1 neck, 5 spines, and 2 shoulders). The leg keypoints KP_L may be located at the major joints of the forelimbs and hindlimbs of the cattle, for example, and may include, for example, a total of eight keypoints (2 hip joints, 2 knees, and 4 ankles).

Each keypoint may be expressed as a 2D coordinate (x, y) and a confidence score (a value between 0 and 1), and for example, only keypoints with a confidence score of 0.6 or higher may be considered valid. Keypoints may be displayed as small circles in the image, and the body keypoints may be distinguished in red and the leg keypoints in blue. In addition, lines may be drawn between related keypoints to visualize the skeletal structure of the cattle.

The body-ground inclination (Angle_T) is the angle between the body and the ground G of the cattle, and may be an important indicator for determining the posture of the cattle. The body-ground inclination may be calculated using five keypoints that constitute the spine among the body keypoints. First, linear regression may be performed on the spine keypoints to obtain the main axis direction vector of the spine. Then, the angle between this vector and the horizontal line (a line parallel to the ground) may be calculated to obtain the body-ground inclination.

In the normal state, the body-ground inclination is approximately in the range of 0° to 60°. When the cattle is standing, the inclination is in the range of 60° to 90°, and when the cattle is lying down normally, the inclination is in the range of 0° to 30°. On the other hand, in a fall state, the body-ground inclination may fall in the range of 90° to 180°. Particularly, when the cattle is completely turned over, the inclination may fall in the range of 150° to 180°.

The keypoint estimation module 1700 may set the body-ground inclination to a flipping candidate state (FCS) when the cattle falls in the range of 90° to 180°. However, additional analysis may be required to distinguish between a normal situation where the cattle is temporarily lying down and an actual flipping state. For this purpose, the movement index MI and the displacement of the leg keypoint may be analyzed.

The movement index (MI) is an index that indicates the duration of a state in which the cattle has almost no internal movement, and may be calculated based on the displacement between frames of the keypoint. The movement index may be calculated as MI=Σ|KPt−KPt−1|/N, where KP is the keypoint position and N is the number of keypoints. A cattle lying normally may periodically show activities such as lifting its head or moving its legs, so the movement index may increase intermittently. On the other hand, the cattle that is flipped may continuously maintain a low value if they struggle and gets tired.

In a state of a candidate for flipping, the movement index may be confirmed as flipping when it remains below the threshold 0.5 pixels/frame for a predetermined duration (15 seconds). This may be to detect a situation in which the cattle has fallen and may not move. The duration may be adjusted in the range of 10 to 20 seconds depending on the size, type, and age of the cattle.

In addition, in the case that the displacement amount of the leg keypoint KP_L for a unit time exceeds the normal displacement amount TD, it may be determined as the flipping state. The leg keypoint displacement amount may be calculated as DL=Σ|Lt−Lt−1|/4, where L may be the leg keypoint position. The normal displacement amount TD is a reference value of the leg movement seen in a normal state of the cattle, and may be generally set to 5 pixels/frame.

In a situation where the fallen cattle struggle, the leg keypoint displacement amount may increase to more than three times the normal displacement amount more than 15 pixels/frame. In the case that this abnormal leg movement continues for more than 2 seconds, it may be determined as a flipping state. This may be to detect a situation where a cattle is flipping and struggling.

The accurate flipping state determination may be made possible through such multi-condition analysis. The keypoint-based posture analysis may be complementary to feature point-based movement analysis to comprehensively detect various conduction situations. By combining the two methods, the accuracy of flipping state detection may be improved to 95% or more, and the false detection rate may be improved to 3% or less.

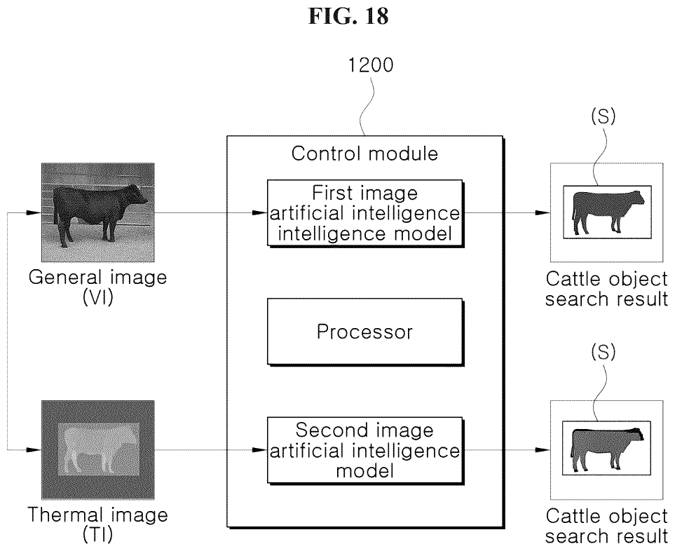

FIG. 18 is a diagram showing an example of utilizing an image artificial intelligence model according to an embodiment of the present disclosure. The control module 1200 may process both a general image VI and a thermal image TI, and may use an artificial intelligence model optimized for each image type.

The general image VI is an image captured by a general camera that detects the visible light band (400 to 700 nm), and may be expressed in RGB or YUV color space. The general image well represents a visual feature such as the shape, color, and texture of the cattle, but is sensitive to lighting conditions, and its performance may deteriorate at night or in low-light environments. The resolution of the general image is 1920×1080 pixels (Full HD), and the bit depth may be 8 bits per channel 24-bit color.

Thermal image TI is an image captured by a thermal imaging camera that detects the infrared band 8˜14 μm, and may be expressed in grayscale or pseudo color according to temperature. Since the thermal image visualizes the body temperature distribution of the cattle, stable detection may be possible even at night without being affected by lighting conditions. The resolution of the thermal image is 640×480 pixels, the temperature resolution may be 0.05° C., and the measurement range may be −20° C. to 150° C.

The first image artificial intelligence model AI_1 may be a model that learns from the general image VI and detects the cattle object. The first image AI model may be based on the YOLOv7 architecture, and CSPDarknet53 may be used as the backbone. The input size of the model is 640×640 pixels, and the output may be the bounding box of the cattle object upper left x, y coordinates, width, height, class small, and confidence score.

The first image AI model AI_1 is trained with at least 20,000 general video small images, which may include various lighting conditions, cattle postures, and barn environments. The training data is divided into 80% training sets and 20% validation sets, and the training parameters may be set to batch size 16, learning rate 0.01, momentum 0.937, and weight decay 0.0005. The performance indicator of the model may be mAP@0.5 (average precision at IoU threshold 0.5 of 0.92 or higher).

The second image AI model AI_2 may be a model trained with thermal images TI to detect cattle objects. The second image AI model may be based on a Faster R-CNN architecture with ResNet−50 as a backbone. The input size of the model may be 640×480 pixels, and the output may be a bounding box, class, and confidence score of the cattle object.

The second image AI model AI_2 is trained with at least 5,000 thermal image images of cattle, and may include various environmental temperatures, body temperature distribution of cattle, and thermal environments of barns. The training data is divided into a 70% training set and a 30% validation set, and the training parameters may be set to, but are not limited to, batch size 8, learning rate 0.005, momentum 0.9, and weight decay 0.0001. The performance indicator of the model may be mAP@0.5 of 0.88 or higher.

The processor P may be hardware that executes the image AI models AI_1, AI_2 within the control module 1200. The processor may be, for example, an AI accelerator with performance equivalent to or higher than NVIDIA Jetson Xavier NX, and may include, but is not limited to, 384 CUDA cores, 48 Tensor cores, and 6 GB LPDDR4× memory. The processor's computational performance is up to 21 TOPS (Tera Operations Per Second), which may provide sufficient performance for real-time image processing and deep learning inference.

By utilizing both image types and AI models, stable cattle object detection may be possible even under various environmental conditions. Normal images show excellent performance in daytime and normal lighting environments, and thermal images may provide stable performance in nighttime and low-light environments. In addition, the results of the two models may be fused to further improve detection accuracy.

The result fusion is performed using a weighted summation method, and the weights of normal and thermal images may be dynamically adjusted according to environmental conditions. For example, in daytime and normal lighting environments, a weight of 0.7 may be given to normal images and a weight of 0.3 to thermal images, and in nighttime and low-light environments, a weight of 0.3 may be given to normal images and a weight of 0.7 to thermal images. This dynamic weight adjustment may be automatically performed through an illumination sensor or an analysis of the brightness histogram of the image.

FIG. 19 is a diagram showing an example of a monitoring screen and state information display according to an embodiment of the present disclosure.

Referring to FIG. 19, an example of a screen output of the monitoring module 1300 is shown. A real-time monitoring image RMV is a real-time image captured by the camera module 1100 in a livestock farm, in which the cattle object S and information about it may be displayed, and the display operation of this monitoring module 1300 may be performed under the control of the control module 1200.

A real-time monitoring image RMV may be located at the center of the monitoring screen and may be displayed at a resolution of at least 1280×720 pixels or more. The image may be updated at a speed of 15 frames per second or more to enable smooth monitoring. In the image, the cattle object S is surrounded by the boundary mark B, and each cattle object is assigned a unique small ID ID_C to identify the object.

The cattle object S represents the cattle object detected in the image, and the boundary mark B may represent the bounding box of the cattle object. The bounding box may be set to include the outermost boundary of the cattle object, the line thickness may be 2˜3 pixels, and the color may be displayed differently depending on the state of the cattle object (normal: green, suspected of flipping: yellow, flipping confirmed: orange, flipping emergency: red.

The cattle ID (ID_C) is a unique number that identifies each cattle object, and may be displayed at the upper left of the cattle object bounding box in the image. The cattle ID may be composed of a combination of numbers and alphabets (e.g., C001, C002, etc.), the font size may be 12˜16 pt, and the color may be displayed as black text on a white background. The small ID may be maintained consistently between frames and between cameras through the ReID (Re-Identification) algorithm.

The state information SI indicates the current state of the cattle object S, and may be displayed as text or an icon at the upper right of the bounding box. The state information may be classified as ‘Normal’, ‘Suspected’, ‘Confirmed’, and ‘Emergency’, and each state may be displayed with a different color code and icon. The text font size may be 12 to 16 pt, and the icon size may be 24×24 pixels.

When the flipping condition is detected, a visual or auditory notification may be provided to the operator through the warning notification area AA. The warning notification area may be located at the top of the monitoring screen, and may display information such as “Flipping detection! (Cattle ID: C001, Location: A3, Time: 15:30:45)” with white text on a red background. The warning notification may be implemented in various forms such as screen flashing(twice per second, red-white alternating), warning sound (85 dB, 1 kHz tone, 0.5 second interval), pop-up message, and the like.

In addition to real-time video, the monitoring screen may provide additional information such as a barn floor plan, a list of cattle state, a notification log, and statistical information. The barn floor plan may be located on the right side of the screen, and may visualize the position of each section and cattle object in the barn. The cattle state list may be located on the left side of the screen, and may display the ID and state of all cattle objects in a table format. The notification log may be located at the bottom of the screen, and may display the recent notification history in chronological order.

The monitoring screen is designed with an intuitive interface, so that the operator may quickly understand the situation and respond. It supports a touchscreen function, so that the operator may touch the screen to select a specific cattle object, zoom in/out the image, or switch to a different camera view. It may also provide functions such as past data lookup, statistical information check, and setting change.

FIG. 20 is a diagram showing an operation and position identification of a lamp module according to an embodiment of the present disclosure.

Referring to FIG. 20, a livestock house plan FL shows the overall layout and sections inside the livestock house, and the lamp module 1500 may be installed in each section, and the light-emitting operation of the lamp module 1500 may be performed by the control of the control module 1200.

The livestock house plan FL is a 2D map that divides the inside of the livestock house into sections of a certain size, and may generally be divided into square sections of 5m×5m in size. Each section may be assigned a unique ID using a combination of alphabets and numbers (e.g., A1, A2, B1, B2, etc.). The barn floor plan may include fixed structures such as walls, pillars, entrances, feeders, and waterers, and the positions of cattle objects.

When the position of the flipped cattle object S is identified as a specific section by the object position identification module 1400, the lamp module 1500 of the corresponding section may be switched to a light-emitting state L_ON. The object position identification module 1400 may use a homography transformation matrix to convert pixel coordinates of the cattle object in the camera image into actual physical coordinates in the barn. The converted coordinates may be mapped to a specific section on the barn floor plan.

The lamp module 1500 may be installed on the ceiling of each section in the barn, and may illuminate the corresponding section using a high-luminance LED. For example, the lamp module may be cylindrical with a diameter of 15 cm and a height of 5 cm, and may be protected by an IP67-rated waterproof and dustproof case. Each lamp module may be controlled independently and may be connected to the control module 1200 through short-range communication such as Zigbee communication, and the type of short-range communication is not limited to Zigbee communication.

The lamp in the light-emitting state L_ON mainly emits red light (wavelength 630 nm, luminous flux 1000 lm or more) to attract the attention of the worker. The light-emitting pattern may be set differently depending on the severity of the flipping state. In the state of suspected conduction, it may blink once per second for 0.5 seconds, off for 0.5 seconds, in the state of confirmed flipping, it may blink twice per second for 0.25 seconds, off for 0.25 seconds, and in the state of emergency flipping, it may blink three times per second for 0.2 seconds, off for 0.13 seconds.

The lamp module 500 may include a red LED light source having a wavelength range of 620 nm to 750 nm, which may be the wavelength range most recognizable to the human eye. The color temperature of the LED may be 1800 K to 2000 K, and the color rendering index CRI may be 80 or higher. The lifespan of the LED may be at least 50,000 hours or more, and the operating temperature range may be −20° C. to 60° C.

This visual notification system may rapidly identify and respond to the position of a flipped cattle in a large barn, which may greatly increase the survival rate of the cattle. The worker may immediately identify the position of the flipped cattle through the light emission of the lamp module, approach it by the shortest path, and take action quickly. This may shorten the time from detection of the fall to response by an average of 5 minutes or more.

FIG. 21 is a diagram showing an example of an operation of a frequency analysis module according to an embodiment of the present disclosure.

Referring to FIG. 21, the control module 1200 may transmit a motion vector sequence (MVS) of the cattle object to the frequency analysis module 1800.

The motion vector sequence (MVS) may be a continuous listing of motion vector data of the cattle object over time. The motion vector may be calculated as a difference in the position of a feature point in consecutive frames, and may be expressed as a 2D vector (dx, dy). The motion vector sequence may include a window of a certain length typically 64 frames, approximately 2.13 seconds, and continuous analysis may be possible with a 50% overlap.

The FFT/DFT converter 1810 may convert the motion vector sequence (MVS) from the time domain to the frequency domain. This is mainly done through Fast Fourier Transform (FFT), which may analyze the movement pattern of the cattle as a frequency spectrum. The FFT may be performed on the x and y components of the movement vector, respectively, and the power spectrum of the two components may be added to analyze the frequency feature of the entire movement.

The frequency spectrum F_Spec may be a graph that shows the energy distribution in the transformed frequency domain. The x-axis may represent the frequency 0˜15 Hz, and the y-axis may represent the energy size. Certain movement patterns have high energy in certain frequency bands. For example, normal walking may concentrate energy in the 1˜2 Hz band, running may concentrate energy in the 2˜4 Hz band, and standing or lying down may concentrate energy in the 0˜0.5 Hz band. On the other hand, irregular and fast movements such as struggling in a flipping state may distribute energy in the 8˜15 Hz band.

The high frequency energy (HFE) may be an energy value of a specific high frequency band 8˜15 Hz in the frequency spectrum F_Spec. The high frequency energy may be calculated as a ratio of high frequency band energy to total energy, and in the case that this value exceeds a high frequency energy threshold TH_HFE, it may be determined as an abnormal movement. The high frequency energy threshold may be set when more than 35% of the total energy is concentrated in the 8˜15 Hz band.

The determination logic 1820 may determine whether the high frequency energy HFE exceeds the high frequency energy threshold TH_HFE, and may transmit the result, whether the flipping condition is satisfied CF, to the control module 200. The determination logic may include advanced analysis techniques such as frequency pattern matching and temporal consistency inspection as well as simple threshold comparison. Frequency domain analysis may identify subtle movement patterns that are difficult to detect in the time domain, and thus may significantly improve the accuracy of flipping state detection.

The steps of a method or algorithm described in connection with the embodiments of the present disclosure may be implemented directly in hardware, in a software module executed by hardware, or in a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or in a computer readable recording medium that is well known in the art.

Although embodiments of the present disclosure have been described above with reference to the accompanying drawings, it is understood that those skilled in the art to which the present disclosure pertains may implement the present disclosure in other specific forms without changing the technical spirit or essential features thereof. Therefore, it should be understood that the embodiments described above are illustrative in all respects and not restrictive.

According to the inventive concept, it is possible to determine whether the animal has abnormal symptoms by learning the standard livestock stall management data and analyzing the body temperature information and behavior information of livestock from livestock image data obtained in real time from livestock such as cattle, thus giving the manager confidence.

According to the inventive concept, it is possible to easily manage livestock by quickly preventing the spread of disease by predicting the disease spread path of an abnormal object. Furthermore, the accuracy of diagnosis can be further improved by predicting the disease spread path of an abnormal object by considering both the object information of the livestock and the surrounding environment information.

According to the inventive concept, by analyzing the body temperature information and behavior information of the livestock from the livestock image data, and quickly determining whether the abnormal symptom of the livestock is a disease symptom, a birthing symptom and a mounting symptom, thus quickly dealing with the progress of each object and easily managing livestock.

According to the inventive concept, when an abnormal situation occurs regardless of time and place, the manager can check in real time whether the animal has abnormal symptoms, thereby providing reliability and convenience to the manager.

Effects of the inventive concept may not be limited to the above-described effects. Although not described herein, other effects of the inventive concept can be clearly understood by those skilled in the art from the following description.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A device for detecting a flipping state of cattle in a barn in real time based on vision recognition, comprising:
a camera module configured to acquiring a first image for monitoring a cattle object in the barn;
a control module configured to analyze the first image received from the camera module and generate a second image to which a display object for the cattle object is added; and
a monitoring module configured to output a real-time monitoring image based on the second image received from the control module,
wherein the display object includes a boundary mark and state information of the cattle object identified in the first image,
wherein the control module is configured to extract a feature point for the cattle object in the first image,
calculate a movement vector of the feature point and estimate a movement trajectory of the cattle object,
determine a change in posture of the cattle object from a numerical change in the estimated movement trajectory,
determine that the change in posture is the flipping state based on the determined change in posture satisfying a flipping condition, and
change the state information of the second image to correspond to the determined flipping state.

2. The device according to claim 1, wherein the flipping condition is:
the numerical change of the movement trajectory is less than or equal to a first threshold value, and
the movement of the cattle object within the boundary mark is greater than or equal to a second threshold value.

3. The device according to claim 2, wherein the control module is configured to:
analyze the movement of the cattle object within the boundary mark using a motion vector field, and
determine movement vector degrees of pixels corresponding to the movement based on the analysis result of the motion vector field.

4. The device according to claim 2, wherein the control module is configured to:
determine based on the estimated value of the movement vector degrees of pixels corresponding to the movement through an optical flow algorithm of the movement of the cattle object within the boundary mark.

5. The device according to claim 2, further comprising:
a frequency analysis module configured to determine whether the flipping condition is satisfied when a temporal sequence of the movement vector of the feature point is analyzed in a frequency domain and exceeds a predefined high-frequency energy threshold value.

6. The device according to claim 2, further comprising:
a keypoint estimation module configured to estimate a keypoint for a body and a leg of the cattle object.

7. The device according to claim 6, wherein the keypoint estimation module is configured to:
calculate an inclination between the body of the cattle object and a ground of the barn,
set the state of the cattle object as a flipping candidate state based on the calculated inclination flipping within a range of 90° to 180°, and
determine the state of the cattle object from the flipping candidate state to the flipping state based on the flipping candidate state continuing for a preset time or longer with a movement index (MI).

8. The device according to claim 7, wherein the keypoint estimation module is configured to:
determine the state of the cattle object as the flipping state based on a displacement amount of the leg keypoint of the cattle object during a unit time exceeds a preset displacement amount while the flipping candidate state continues for a preset time or longer with the movement index (MI).

9. The device according to claim 2, further comprising:
an object position identification module configured to identify a position of the cattle object determined to be in the flipping state by the control module within the barn; and
a plurality of lamp modules configured to emit light in accordance with a signal received from the control module and be arranged in a plurality of compartments within the barn.

10. The device according to claim 9, wherein the control module is configured to:
control the lamp module arranged in the compartment corresponding to the position of the cattle object identified by the object position identification module among the plurality of compartments to emit light.
